(19) United States
(12) Patent Application Publication
(10) Pub. No.: US 2025/0127182 A1
(43) Pub. Date: Apr. 24, 2025

(54) SENSORY MODIFIERS FOR DAIRY SUBSTITUTE COMPOSITIONS

(71) Applicant: CARGILL, INCORPORATED, Wayzata, MN (US)

(72) Inventors: John Phillip MILLER, Minneapolis, MN (US); Rama Krishna SARANGAPANI, St. Michael, MN (US); Wade Nolan SCHMELZER, St. Louis Park, MN (US)

(73) Assignee: CARGILL, INCORPORATED, Wayzata, MN (US)

(21) Appl. No.: 18/570,053

(22) PCT Filed: Jun. 17, 2022
(86) PCT No.: PCT/US2022/073013

§ 371 Date: Dec. 13, 2023

Related U.S. Application Data
(60) Provisional application No. 63/212,396, filed on Jun. 18, 2021.
(60) Provisional application No. 63/227,635, filed on Jul. 30, 2021.

(51) Int. Cl. A23C 20/02; A23C 11/10; A23G 9/38; A23G 9/42; A23L 11/50

(52) U.S. Cl. CPC A23C 20/025; A23C 11/103; A23G 9/38; A23G 9/42; A23L 11/50

(57) ABSTRACT

A dairy substitute composition having a plant-based protein and/or plant-based milk product and a sensory modifier, such that the dairy substitute has reduced plant-protein flavor, increased sourness, increased lactic flavor, or a combination there of relative to an equivalent dairy substitute composition without the sensory modifier. For example, the dairy substitute may be a dairy-free cheese, a dairy-free yogurt, or a dairy-free ice cream.

### CROSS-REFERENCE TO RELATED APPLICATIONS

This application claims priority to U.S. Provisional Application No. 63/212,396, filed Jun. 18, 2021, and U.S. Provisional Application No. 63/227,635, filed Jul. 30, 2021, each of which is incorporated herein by reference in its entirety.

### BACKGROUND

Demand for animal protein free dairy substitutes is increasing for a variety of reasons. Many consumers prefer dairy substitutes that perform most similarly to dairy-based cheese, yogurt, ice cream, and the like. However, in some cases, consumers may discern differences in the sensory and temporal taste profile of the dairy substitutes prepared without animal proteins that are unpleasant or dissimilar from animal-milk based dairy compositions. These sensory attributes can limit consumers preferences for these products and limit the applications of dairy substitutes.

### SUMMARY

The present disclosure provides diary compositions containing a hydrocolloid, a starch, or a combination thereof: a lipid composition, a plant-based protein, or a combination thereof; and between 0.001% (wt) and 1.0% (wt) of a sensory modifier comprising a dicaffeoylquinic acid or salt thereof; and at least one compound selected from the group consisting of monocaffeoylquinic acids, monoferuloylquinic acids, diferuloylquinic acids, monocoumaroylquinic acids, dicoumaroylquinic acids, and salts thereof. Sourness of the composition may be increased relative to sourness in an equivalent composition prepared without the sensory modifier. The sensory modifier may be present in the composition in an amount effective to increase sourness such that a sourness intensity value of the composition is increased by at least 0.5 units relative to a sourness intensity value of an equivalent composition without the sensory modifier, wherein sourness intensity value is measured by the Standardized Sourness Intensity Test. The composition may comprise a plant-based protein and plant protein flavor of the composition is reduced relative to plant protein flavor in an equivalent composition prepared without the sensory modifier. The composition may comprise lactic acid and lactic flavor of the composition is increased relative to lactic flavor in an equivalent composition prepared without the sensory modifier. The composition may be a dairy-free cheese, a dairy-free yogurt, or a dairy-free ice cream.

The sensory modifier may comprise less than 0.3% (wt) of malonate, malonic acid, oxalate, oxalic acid, lactate, lactic acid, succinate, succinic acid, malate, or malic acid: or less than 0.05% (wt) of pyruvate, pyruvic acid, fumarate, fumaric acid, tartrate, tartaric acid, sorbate, sorbic acid, acetate, or acetic acid: or less than 0.05% (wt) of chlorophyll: or less than 0.1% (wt) of furans, furan-containing chemicals, theobromine, theophylline, or trigonelline as a weight percentage on a dry weight basis of the sensory modifier. The sensory modifier may comprise 0) % (wt) of malonate, malonic acid, oxalate, oxalic acid, lactate, lactic acid, succinate, succinic acid, malate, or malic acid: or 0% (wt) of chlorophyll. The sensory modifier may be 0.001% to 0.5%, 0.005% to 0.1%, 0.01% to 0.05% by weight of the composition. The dicaffeoylquinic acid or dicaffeoylquinic salt may comprise at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof. In some aspects, the total of all dicaffeoylquinic acids and dicaffeoylquinic salts present in the sensory modifier comprises 10% (wt) or more, 15 wt % or more, 20% (wt) or more, 25% (wt) or more, 30% (wt) or more, 35% (wt) or more, 40% (wt) or more, 45% (wt) or more. 50% (wt) or more, 60% (wt) or more, 70% (wt) or more, 25-75% (wt), or 40-60% (wt) of a total weight of the sensory modifier. The sensory modifier may comprise a monocaffeoylquinic component selected from the group consisting of chlorogenic acid, neochlorogenic acid, cryptochlorogenic acid, and salts thereof. The sensory modifier may comprise a monocaffeoylquinic component and a dicaffeoylquinic component that together comprise more than 50% (wt), preferably more than 60% (wt), more than 70% (wt), more than 80% (wt), more than 90% (wt), or more than 95% (wt) of the sensory modifier. The composition may comprise between 0.001% (wt) and 0.5% (wt), between 0.005% (wt) and 0.25% (wt), or between 0.01% (wt) and 0.1% (wt) of the sensory modifier.

The composition may comprise a plant-based protein selected from the group consisting of pea protein, soy protein, corn protein, potato protein, wheat protein, pulse protein, chickpea protein, canola protein, rice protein, sunflower protein, and combinations thereof. The composition may comprise 0.5% (wt) to 20% (wt), 1% (wt) to 15% (wt), 2% (wt) to 10% (wt), or 3% (wt) to 8% (wt) of a plant-based protein isolate.

The composition may comprise 1% (wt) to 30% (wt), 5% (wt) to 25% (wt), or 10% (wt) to 20% (wt) of the lipid composition. The lipid composition may comprise an oil selected from the group consisting of coconut oil, palm oil, sunflower oil, soy oil, canola oil, vegetable oil, and combinations thereof.

The composition may comprise 1% (wt) to 20% (wt) or 2% (wt) to 15% (wt) starch. The starch may comprise pregelatinized starch, modified starch, or combinations thereof.

The composition may comprise a hydrocolloid comprising guar gum, xanthan gum. carrageenan, locust bean gum, cellulose, konjac gum, or combinations thereof. The composition may comprise between 0.1% (wt) and 10.0% (wt), between 0.5% (wt) and 8.0% (wt), or between 1.0% (wt) and 5.0% (wt) of the hydrocolloid.

The composition may comprise between 0.01% (wt) and 10.0% (wt), between 0.05% (wt) and 8.0% (wt), or between 0.1% (wt) and 5.0% (wt) of lecithin.

The composition may comprise between 15% and 80%, between 20% and 70%, between 15% and 50%, between 20% and 40%, between 50% and 80%, or between 55% and 75% by weight of a plant-based milk product. The composition comprises between 1% and 80%, between 5% and 75%, between 15% and 70%, between 45% and 65%, between 50% and 60%, between 1% and 20%, or between 5% and 15% by weight water. The combination of water and plant-based milk product in the composition may be between 50% and 95%, between 60% and 92%, or between 60% and 90% by weight of the composition.

The disclosure also provides a method for increasing lactic flavor in a dairy substitute composition, the method comprising, adding a sensory modifier to a dairy substitute composition comprising a hydrocolloid, a starch, or a combination thereof: a lipid composition, a plant-based protein, or a combination thereof: to form a modified dairy substitute, the sensory modifier comprising a dicaffeoylquinic acid or salt thereof and at least one compound selected from the group consisting of monocaffeoylquinic acids, monoferuloylquinic acids, diferuloylquinic acids. monocoumaroylquinic acids, dicoumaroylquinic acids, and salts thereof, wherein lactic flavor of the composition is increased relative to lactic flavor in an equivalent composition prepared without the sensory modifier.

The disclosure also provides a method for increasing sourness in a dairy substitute composition, the method comprising, adding a sensory modifier to a dairy substitute composition comprising a hydrocolloid, a starch, or a combination thereof: a lipid composition, a plant-based protein, or a combination thereof: to form a modified dairy substitute, the sensory modifier comprising a dicaffeoylquinic acid or salt thereof and at least one compound selected from the group consisting of monocaffeoylquinic acids, monoferuloylquinic acids, diferuloylquinic acids. monocoumaroylquinic acids, dicoumaroylquinic acids, and salts thereof, wherein sourness of the composition is increased relative to sourness in an equivalent composition prepared without the sensory modifier.

### BRIEF DESCRIPTION OF THE FIGURES

This patent or application contains at least one drawing executed in color. Copies of this patent or patent application publication with color drawings will be provided by the Office upon request and the payment of the necessary fee.

The drawings illustrate generally, by way of example, but not by way of limitation, various aspects discussed herein.

FIG. 1 shows a spider chart of the sensory results described in Example 3.

FIGS. 2A-2E show photos of the plant-based protein samples prepared according to Example 12.

FIGS. 3A-3D show photos of the pea protein isolate samples prepared according to Example 13.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document: for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

This disclosure relates to various dairy substitute compositions which have improved sensory attributes, such as reduced plant protein flavor and/or reduced bitterness. The disclosure also relates, generally, to a sensory modifier and uses thereof. In various aspects, the sensory modifier contains one or more caffeoyl-substituted quinic acid, and salts thereof. The disclosure further relates to methods of reducing undesirable attributes associated with plant-based protein components and providing an improved composition relative to plant protein containing dairy substitutes which lack the sensory modifier described herein.

### Compositions

The present disclosure provides dairy substitute compositions containing various improvements which serve to modify the sensory perception thereof in use. The dairy substitute may be a dairy-free cheese, a dairy-free yogurt, a dairy-free ice cream, and the like.

As used herein, the teams “dairy substitute” and “dairy substitute composition,” are used interchangeably and refer to compositions that mimic the general appearance, nutritional content, and/or tase of dairy products produced using animal milk products without containing any animal based milk. In some aspects, the dairy substitute is completely free of any animal-based milk or animal-based milk protein. The dairy substitutes may be dairy-free cheese, dairy-free yogurt, dairy-free ice cream, and the like.

As used herein, the term “plant-based protein composition” refers to composition comprising a plant-based protein. For example, the plant-based protein may be, but is not limited to, pea protein, soy protein, corn protein, potato protein, wheat protein, pulse protein, chickpea protein, canola protein, rice protein, sunflower protein, and combinations thereof. The plant-based protein composition may include a textured plant-based protein, a powdered plant-based protein, a plant-based protein isolate, or combinations thereof.

As used herein, “textured protein” and “textured plant-based protein” are used interchangeably and refer to edible food ingredients processed from an edible protein sources and characterized by having a structural integrity and identifiable structure such that individual units, appearing as fibers, shreds, chunks, bits, granules, slices, and the like, will withstand hydration and cooking or other procedures used in the production of food for consumption. In general, textured plant-based proteins may be used to alter or enhance texture and bind water. Edible protein sources from which textured proteins are produced may include, but are not limited to, legumes (e.g., pulse protein), pea, soy, corn, wheat, chickpea, potato, rice, sunflower, and the like. Textured proteins may include, but are not limited to, textured pea protein, textured soy flour, textured soy concentrate, textured wheat protein, textured potato protein, or combinations thereof. Methods for protein texturization and known and described in the art, and may include, for example, high temperature and pressure extrusion, spinning, freeze texturization, chemical or enzymatic texturization, and the like.

Powdered plant-based proteins and plant-based protein isolates are generally soluble forms of plant-based proteins used as food ingredients. Plant-based protein isolates or powders may include, but are not limited to, pea protein, defatted soy flour, defatted soy isolate, soy concentrate, vital wheat gluten, potato protein, corn protein isolate, rice protein, sunflower protein, or combinations thereof.

The dairy substitute composition described herein may include one or more lipid compositions, for example a fat, an oil, or combinations thereof. In general, fats refer to lipid compositions that are solid at room temperature, whereas oils are liquid at room temperature. The lipid compositions may include saturated fatty acids (also referred to as “saturated fats”), unsaturated fatty acids (also referred to as “unsaturated fats”), or combinations thereof. The lipid composition may include, but are not limited to, vegetable oil, coconut oil, palm oil, sunflower oil, soy oil, canola oil, or combinations thereof. The dairy substitute composition may include between 1% and 80%, between 1% and 70%, between 1% and 10%, between 1% and 5%, between 5% and 30%, between 10% and 25%, between 10% and 75%, or between 15% and 70% by weight of a lipid composition depending on the type of dairy substitute. An ordinarily skilled artisan will understand the appropriate lipid composition inclusion rate for a given dairy substitute composition.

The lipid composition may also be provided in the dairy composition in the form of a plant-based milk product. For example, the dairy substitute may include a plant-based milk product such as, but not limited to, coconut milk, coconut cream, almond milk, almond cream, almond butter, soy milk, oat milk, hemp milk, hazelnut milk, rice milk, pea milk, and combinations thereof. In addition to providing at least a portion of or all of the lipid components of the dairy substitute, the plant-based milk product may also provide additional protein, fiber, vitamins, and minerals to the dairy substitute in addition to providing flavor to the dairy substitute. The dairy substitute composition may include between 15% and 80%, between 20% and 70%, between 15% and 50%, between 20% and 40%, between 50% and 80%, or between 55% and 75% by weight of a plant-based milk product.

The dairy substitute may include water. For example, the dairy substitute may include between 1% and 80%, between 5% and 75%, between 15% and 70%, between 45% and 65%, between 50% and 60%, between 1% and 20%, or between 5% and 15% by weight of water depending on the type of dairy substitute.

In some aspects, the dairy substitute includes both water and a plant-based milk. The total of the water and plant-based milk may be between 50% and 95%, between 60% and 92%, or between 60% and 90% by weight of the dairy substitute composition.

The dairy substitute may include fiber. The fiber may include, but is not limited to, pectin, apple fiber, psyllium, flax fiber, rice bran extract, Konjac flour, and the like. The dairy substitute may include between 0.01% (wt) and 3% (wt), between 0.05% (wt) and 2% (wt), or between 0.1% (wt) and 2% (wt) of fiber. The dairy substitute may include fiber in an amount up to 0.5% (wt), up to 1% (wt), up to 1.5% (wt), up to 2% (wt), up to 2.5% (wt), or up to 3% (wt).

The dairy substitute may include starch. The starch may include a pregelatinized starch, a modified starch, or combinations thereof. The starch may include, but is not limited to, corn starch, potato starch, tapioca starch, and the like. The dairy substitute may include between 0.5% (wt) and 25% (wt), between 1.0% (wt) and 20% (wt), or between 2% (wt) and 18% (wt) of starch.

The dairy substitute may include a hydrocolloid. For example, the dairy substitute may include guar gum, xanthan gum, locust bean gum, carrageenan, cellulose, konjac gum, and combinations thereof. The dairy substitute may include between 0.01% and 5%, between 0.05% and 4.5%, between 0.1% and 4.0%, or between 0.5% and 3.8% by weight of hydrocolloid. The dairy substitute may include up to 5%, up to 4.5%, up to 4.0%, up to 3.8%, up to 3.5%, up to 2.5%, up to 2.0%, or up to 1.0% by weight of hydrocolloid.

The dairy substitute may include lecithin. The dairy substitute may include between 0.01% and 10%, between 0.05% and 8.0%, or between 0.1% and 5% by weight lecithin.

The dairy substitute may include a preservative. For example, the dairy substitute may include a preservative such as, but not limited to potassium sorbate. The dairy substitute may include a preservative in an amount up to 0.1%, up to 0.5%, or up to 1.0% by weight of the dairy substitute.

The dairy substitute may include a flavor or seasoning. For example, the dairy substitute may include a natural or artificial flavor(s) and/or seasonings. Seasonings may include, but are not limited to, sweetener(s), salt (e.g., sodium chloride, potassium chloride, and the like), cocoa, chocolate, cinnamon, nutmeg, coconut, almond, combinations thereof, and the like. The dairy substitute may include between 1% and 20%, between 1.5% and 10%, between 5% and 20%, or between 2% and 18% of sweetener. The dairy substitute may be free of any sweetener. The dairy substitute may include between 0.001% and 3.0%, between 0.01% and 2.0%, or between 0.025% and 1.75% of a salt. The dairy substitute may be free of salt.

The dairy substitute may include a sweetener. Suitable sweeteners are known and described in the art. The sweetener can be at least one of a non-caloric sweetener or a caloric sweetener. The sweetener can be any type of sweetener, for example, a sweetener obtained from a plant or plant product, or a physically or chemically modified sweetener obtained from a plant, or a synthetic sweetener. Exemplary sweeteners include steviol glycosides, mogrosides, sucrose, fructose, glucose, erythritol, maltitol, lactitol, sorbitol, mannitol, xylitol, tagatose, trehalose, galactose, rhamnose, cyclodextrin (e.g., a-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, sucralose, acesulfame K, aspartame, saccharin, coupling sugars, soy bean oligosaccharides, and combinations thereof. D- or L-configurations can be used when applicable. Suitable sweeteners and aspects thereof are also described in PCT International Publication Nos. WO 2019/071220 and WO 2019/071182 and in US Patent Application Publication Nos. 2019/0223481 and 2019/0223483, each of which is incorporated by reference herein in its entirety.

The dairy substitute may include an acid. Suitable acids include, but are not limited to, citric acid, lactic acid, sorbic acid, malic acid, combinations thereof, and the like. The dairy substitute may include an acid in an amount up to 0.001%, up to 0.005%, up to 0.01%, up to 0.1%, up to 1.0%, up to 1.5%, or up to 2.0% of the dairy substitute. The dairy substitute may include between 0.0001% and 2.0%, between 0.0002% and 1.5%, between 0.0003% and 1.0% by weight of an acid.

In some aspects, the dairy substitute is a dairy-free cheese and includes a hydrocolloid, a starch, a lipid composition, a plant-based protein, and a sensory modifier as described herein. The dairy-free cheese may include between 0.01% and 10%, between 0.1% and 8%, between 0.5% and 5%, or between 1% and 4% by weight of a hydrocolloid: between 1% and 20%, between 5% and 18%, or between 10% and 15% by weight of a starch: between 5% and 30%, between 10% and 25%, or between 15% and 20% by weight of a lipid composition: between 1% and 15, between 2% and 10%, or between 3% and 8% by weight of a plant-based protein, and a sensory modifier as described herein. The dairy-free cheese may also include between 30% and 70%, between 40% and 65%, or between 45% and 60% by weight water: between 0.0001% and 2.0%, between 0.0002% and 1.5%, between 0.0003% and 1.0% by weight of an acid: between 0.001% and 3.0%, between 0.01% and 2.0%, or between 0.025% and 1.75% of a salt; or combinations thereof.

In some aspects, the dairy substitute is a dairy-free yogurt and includes a starch, a lipid composition, a plant-based protein, and a sensory modifier as described herein. The dairy-free yogurt may include between 0.5% and 10%, between 1% and 8%, or between 2% and 7% by weight of starch: between 0.1% and 10%, between 0.5% and 8%, or between 1% and 5% by weight of a plant-based protein: between 15% and 80% or between 20% and 75% by weight of a plant-based milk comprises a lipid composition; and a sensory modifier as described herein. The dairy-free yogurt may also include between 0.01% (wt) and 3% (wt), between 0.05% (wt) and 2% (wt), or between 0.1% (wt) and 2% (wt) of fiber: between 15% and 80% or between 20% and 75% by weight water: between 0.1% and 15%, between 0.5% and 10%, or between 1.0% and 8% sweetener: between 0.001% and 3.0%, between 0.01% and 2.0%, or between 0.025% and 1.75% of a salt; or combinations thereof. The combination of water and plant-based milk in the dairy-free yogurt may be between 50% and 95%, between 60% and 92%, or between 60% and 90% by weight of the dairy-free yogurt.

In some aspects, the dairy substitute is a dairy-free ice cream and includes a hydrocolloid, a lipid composition, a plant-based protein, and a sensory modifier as described herein. The dairy-free ice cream may include between 0.01% and 10%, between 0.05% and 5%, or between 0.1% and 3% by weight of hydrocolloid: between 30% and 70%, between 40% and 65%, or between 45% and 60% by weight of a plant-based milk: between 0.1% and 10%, between 0.5% and 8%, or between 1% and 5% of a lipid composition; and a sensory modifier as described herein. The dairy-free ice cream may also include between 0.1% and 20%, between 0.5% and 18%, or between 1% and 15% by weight water: between 1% and 30%, between 2% and 25%, or between 5% and 20% by weight sweetener: or combinations thereof. The combination of water and plant-based milk in the dairy-free ice cream may be between 50% and 95%, between 60% and 92%, or between 60% and 90% by weight of the dairy-free ice cream.

### Sensory Modifier

A sensory modifier is a compound or composition that in certain amounts changes the sensory characteristics or sensory attributes of a consumable, e.g., a beverage, a food product, etc. Non-limiting examples of sensory characteristics that a sensory modifier can change include bitterness, sourness, numbness, astringency, creaminess, metallicness, cloyingness, dryness, sweetness, starchiness, mouthfeel, temporal aspects of sweetness, temporal aspects of saltiness, temporal aspects of bitterness, or temporal aspects of any sensory characteristic described herein, as well as flavor notes, such as licorice, vanilla, prune, cotton candy, lactic, umami, and molasses flavor notes. The sensory modifier may enhance a sensory characteristic, such as enhancing sourness and enhancing lactic favor: may suppress a sensory characteristic, such as reducing bitterness or reducing plant-protein flavor: or may change the temporal aspects of a sensory characteristic, e.g., by delaying bitterness onset or reducing bitterness or saltiness linger, or a combination thereof. In some aspects, the amount employed in a dairy substitute composition alters at least one sensory characteristic, e.g., the composition may have reduced bitterness, reduced plant-protein flavor, reduced saltiness, enhanced sourness, enhanced lactic flavor, or a combinations thereof relative to an equivalent dairy substitute lacking the sensory modifier.

The present disclosure provides a sensory modifier comprising one or more caffeoyl-substituted quinic acids, and salts thereof. In various aspects, the caffeoyl-substituted quinic acids comprise an ester derived from the carboxylic acid of caffeic acid and an alcohol of quinic acid. A “caffeoyl-substituted quinic acid” or “caffeoylquinic acid” as the terms are used herein, include monocaffeoylquinic acids and dicaffeoylquinic acids and salts thereof. Monocaffeoylquinic acids comprise an ester derived from a single caffeic acid and a quinic acid (e.g., chlorogenic acid (5-O-caffeoylquinic acid), neochlorogenic acid (3-O-caffeoylquinic acid), and cryptochlorogenic acid (4-O-caffeoylquinic acid)). Dicaffeoylquinic acids comprise an ester derived from two caffeic acids and a quinic acid (e.g., 1,3-dicaffeoylquinic acid, 1,4-dicaffeoylquinic acid, 1,5-dicaffeoylquinic acid. 3,4-dicaffeoylquinic acid, 3,5-dicaffeoylquinic acid, and 4,5-dicaffeoylquinic acid)). Thus, the sensory modifier includes both acid forms and salt forms of caffeoyl-substituted quinic acids. Free acid forms of various caffeoyl-substituted quinic acids are shown in Table 1.

TABLE 1
Structures of various caffeoyl-substituted quinic acids.

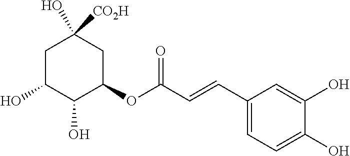 [SMILES: O=C(/C=C/c1ccc(O)c(O)c1)O[C@@H]1C[C@](O)(C(=O)O)C[C@@H](O)[C@H]1O]

Chlorogenic acid (5-O-caffeoylquinic acid)

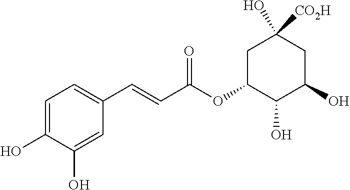 [SMILES: O=C(/C=C/c1ccc(O)c(O)c1)O[C@@H]1C[C@@](O)(C(=O)O)C[C@@H](O)[C@@H]1O]

Neochlorogenic acid (3-O-caffeoyquinic acid)

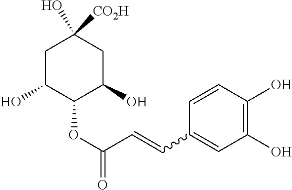 [SMILES: O=C(C=Cc1ccc(O)c(O)c1)O[C@H]1[C@H](O)C[C@](O)(C(=O)O)C[C@H]1O]

Cryptochlorogenic acid (4-O-caffeoylquinic acid)

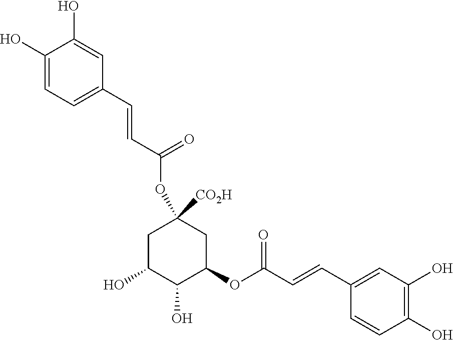 [SMILES: O=C(/C=C/c1ccc(O)c(O)c1)O[C@@H]1C[C@](OC(=O)/C=C/c2ccc(O)c(O)c2)(C(=O)O)C[C@@H](O)[C@H]1O]

1,5-Dicaffeoylquinic acid

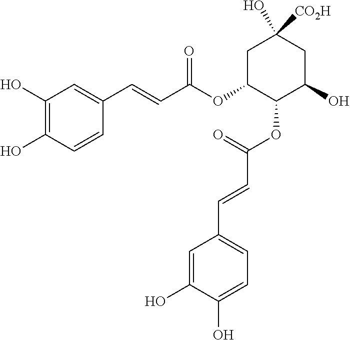 [SMILES: O=C(/C=C/c1ccc(O)c(O)c1)O[C@H]1[C@H](O)C[C@](O)(C(=O)O)C[C@H]1OC(=O)/C=C/c1ccc(O)c(O)c1]

3,4-Dicaffeoylquinic acid

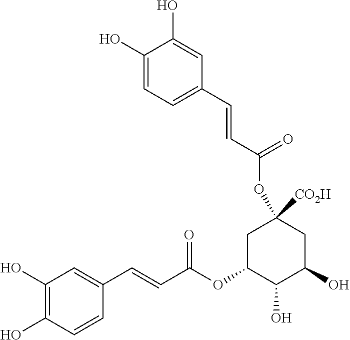 [SMILES: O=C(/C=C/c1ccc(O)c(O)c1)O[C@@H]1C[C@@](OC(=O)/C=C/c2ccc(O)c(O)c2)(C(=O)O)C[C@@H](O)[C@@H]1O]

1,3-Dicaffeoylquinic acid

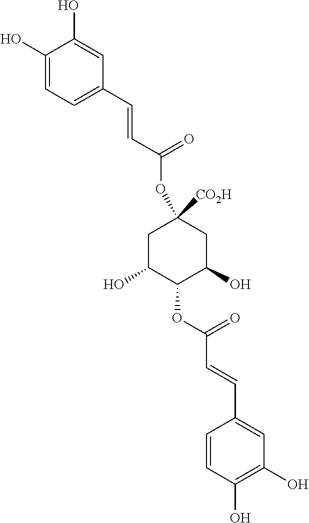 [SMILES: O=C(/C=C/c1ccc(O)c(O)c1)O[C@H]1[C@H](O)C[C@](OC(=O)/C=C/c2ccc(O)c(O)c2)(C(=O)O)C[C@H]1O]

1,4-Dicaffeoylquinic acid

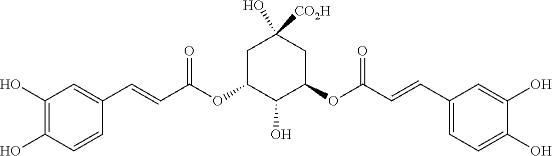 [SMILES: O=C(/C=C/c1ccc(O)c(O)c1)O[C@@H]1C[C@](O)(C(=O)O)C[C@@H](OC(=O)/C=C/c2ccc(O)c(O)c2)[C@H]1O]

3,5-Dicaffeoylquinic acid

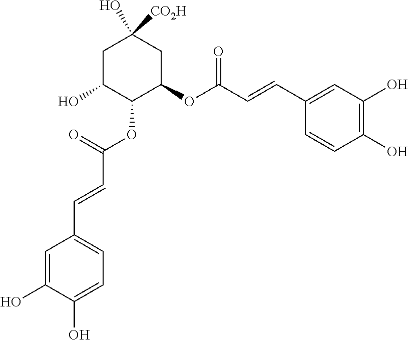 [SMILES: O=C(/C=C/c1ccc(O)c(O)c1)O[C@@H]1[C@H](O)C[C@@](O)(C(=O)O)C[C@H]1OC(=O)/C=C/c1ccc(O)c(O)c1]

4,5-Dicaffeoylquinic acid

In various aspects, the sensory modifier further comprises one or more of quinic acid, caffeic acid, ferulic acid, sinapic acid, p-coumaric acid, an ester of quinic acid, an ester of caffeic acid, an ester of ferulic acid, an ester of sinapic acid, an ester of p-coumaric acid, an ester of caffeic acid and quinic acid, an ester of caffeic acid and quinic acid comprising a single caffeic acid moiety, an ester of caffeic acid and quinic acid comprising more than one caffeic acid moiety, an ester of ferulic acid and quinic acid, an ester of ferulic acid and quinic acid comprising a single ferulic acid moiety, an ester of ferulic acid and quinic acid comprising more than one ferulic acid moiety, an ester of sinapic acid and quinic acid, an ester of sinapic acid and quinic acid comprising a single sinapic acid moiety, an ester of sinapic acid and quinic acid comprising more than one sinapic acid moiety, an ester of p-coumaric acid and quinic acid, an ester of p-coumaric acid and quinic acid comprising a single p-coumaric acid moiety, an ester of p-coumaric acid and quinic acid comprising more than one p-coumaric acid moiety, a di-ester of quinic acid containing one caffeic acid moiety and one ferulic acid moiety, a caffeic ester of 3-(3,4-dihydroxyphenyl) lactic acid, a caffeic acid ester of tartaric acid, a caffeic acid ester of tartaric acid containing more than one caffeic acid moieties, and/or isomers thereof, and the corresponding salts.

In some aspects, the sensory modifier comprises one or more of chlorogenic acid (5-O-caffeoylquinic acid), neochlorogenic acid (3-O-caffeoylquinic acid), cryptochlorogenic acid (4-0-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, rosmarinic acid, caftaric acid (monocaffeoyltartaric acid), cichoric acid (dicaffeoyltartaric acid) and salts, and/or isomers thereof, and the corresponding salts.

In some aspects, the sensory modifier consists essentially of one or more compounds selected from the list consisting of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and any combination thereof, isomers thereof, and the corresponding salts. In various aspects, one or more alcohol of the caffeoyl moiety is replaced with a hydrogen or substituted with an C1-C10 alkyl (e.g., methyl, ethyl, propyl, etc), C1-C10 alkenyl, C6-C10 aryl, C2-C10 acyl, acrylate, caffeoyl, o-coumaroyl, p-coumaroyl, m-coumaroyl, cinnamoyl, 4-hydroxycinnamoyl, feruloyl, iso-feruloyl, sinapoyl, galloyl, sulfate, phosphate, or phosphonate. Thus, modified and substituted caffeic acid moieties result in a cinnamic acid, o-coumaroyl, p-coumaric acid, m-coumaric acid, ferulic acid, and the acyl and ester forms thereof. In various aspects, one or more alcohol of the quinic acid moiety is substituted with an C1-C10 alkyl (e.g., methyl, ethyl, propyl, etc), C1-C10 alkenyl, C6-C10 aryl, C2-C10 acyl, acrylate, caffeoyl, o-coumaroyl, p-coumaroyl, m-coumaroyl, cinnamoyl, 4-hydroxycinnamoyl, feruloyl, iso- feruloyl, sinapoyl, galloyl, sulfate, phosphate, or phosphonate.

The sensory modifier can include one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Examples of a ferulic ester of quinic acid includes 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, and combinations thereof. An example of a caffeic ester of 3-(3,4-dihydroxyphenyl)lactic acid is rosmarinic acid. Examples of a caffeic acid ester of tartaric acid includes cichoric acid (dicaffeoyltartaric acid) and caftaric acid (monocaffeoyltartaric acid) and combinations thereof.

In an alternative aspect, the sensory modifier is a mixture consisting of one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Such sensory modifier also includes salts thereof so as to have a salt fraction and an acid fraction. It is thus further envisaged that each of the various aspects described herein related to caffeoylquinic acid and other sensory modifiers can be equally applicable to this alternative.

### Caffeic Acid has the Structure:

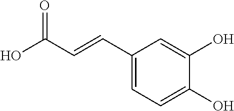 [SMILES: O=C(O)/C=C/c1ccc(O)c(O)c1]

### Quinic Acid has the Structure:

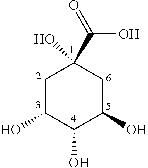 [SMILES: O=C(O)[C@]1(O)C[C@@H](O)[C@@H](O)[C@H](O)C1]

The structure provided above is D-(−)-quinic acid and the numbers shown correspond to current IUPAC numbering.

In various aspects, the sensory modifier can be enriched for one or more of caffeic acid, monocaffeoylquinic acids, and dicaffeoylquinic acids. The term “enriched” refers to an increase in an amount of one of caffeic acid, monocaffeoylquinic acids, and dicaffeoylquinic acids relative to one or more other compounds that are present in the sensory modifier. A sensory modifier that is enriched for one or more of caffeic acid, monocaffeoylquinic acids, and dicaffeoylquinic acids can modify the sensory attributes of the dairy substitute composition.

The sensory modifier enriched for one or more dicaffeoylquinic acids can modify the sensory attributes of a dairy substitute composition. A sensory modifier that is enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more dicaffeoylquinic acids as a percentage of the total weight of the sensory modifier.

In various aspects, at least or about 10 wt %, 15 wt %, 20 wt %, 25 wt %, 30 wt %, 35 wt %, 40 wt %, 45 wt %, or at least or about 50 wt % of the total sensory modifier can be monocaffeoylquinic acids and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be chlorogenic acid (5-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be neochlorogenic acid (3-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be cryptochlorogenic acid (4-O-caffeoylquinic acid) and salts thereof.

In various further aspects, at least or about 10 wt %, 15 wt %, 20 wt %, 25 wt %, 30 wt %, 35 wt %, 40 wt %, 45 wt %, or at least or about 50 wt % of the total sensory modifier can be 1,3-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,4-dicaffeoylquinic acid and salts thereof.

In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 4,5-dicaffeoylquinic acid and salts thereof.

The sensory modifier can, for example, have a weight ratio of total monocaffeoylquinic acids and salts to total dicaffeoylquinic acids and salts of 20:1 to 1:20, e.g., from 3:1 to 1:20. In various aspects, the sensory modifier has a weight ratio from 15:1 to 1:15, from 10:1 to 1:10, from 5:1 to 1:5, from 3:1 to 1:3, from 2:1 to 1:2, from 1.5:1 to 1:1.5, from 5:1 to 1:1, from 3:1 to 1:1, from 2:1 to 1:1, from 1.5:1 to 1:1.1, from 1:1 to 1:20, from 1:1 to 1:15, from 1:1 to 1:10, from 1:5 to 1:20, from 1:5 to 1:15, from 1:5 to 1:10, from 1:2 to 1:20, from 1:2 to 1:15, from 1:2 to 1:10, from 1:2 to 1:5, from 1:1 to 1:3, from 1:1 to 1:2, or from 1:1 to 1:1.5 monocaffeoylquinic acid and salts thereof:dicaffeoylquinic acids and salts thereof. In some aspects, the sensory modifier has a greater amount, by weight, of dicaffeoylquinic acids and salts of dicaffeoylquinic acids compared to the amount of monocaffeoylquinic acids and salts of monocaffeoylquinic acids. In various aspects, the sensory modifier has a ratio of about 1:1 of monocaffeoylquinic acid:dicaffeoylquinic acids, including salts thereof.

The sensory modifier provided herein may contain a portion that is in salt form (corresponding to a “salt fraction”) and a portion that is in acid form (corresponding to an “acid fraction”). In various aspects, the salt fraction accounts for at least 50 wt % of the total sensory modifier. In various aspects, the sensory modifier comprises a salt fraction and an acid fraction, wherein the salt fraction comprises one or more of a salt of a monocaffeoylquinic acid and a salt of a dicaffeoylquinic acid, wherein the acid fraction comprises one or more of a monocaffeoylquinic acid and a dicaffeoylquinic acid, and wherein the salt fraction comprises at least 50 wt % of the total sensory modifier.

For example, the salt fraction comprises at least or about 50 wt %, 55 wt %, 60 wt %, 65 wt %, 70 wt %, 75 wt %, 80 wt %, 85 wt %, or at least or about 90 wt % of the total sensory modifier. In further aspects, the salt fraction comprises less than or about 60 wt %, 65 wt %, 70 wt %, 75 wt %, 80 wt %, 85 wt %, or less than or about 90 wt % of the total sensory modifier. In yet further aspects, the salt fraction comprises 50 wt % to 90 wt %, 50 wt % to 80 wt %, 50 wt % to 75 wt %, 60 wt % to 90 wt %, 60 wt % to 80 wt %, 65 wt % to 80 wt %, or 65 wt % to 75 wt % of the total sensory modifier. Unless otherwise specified the wt % of the salt fraction should be calculated inclusive of the balancing cation species.

In further examples, the acid fraction comprises at least or about 5 wt %, 10 wt %, 15 wt %, 20 wt %, 25 wt %, 30 wt %, 35 wt %, 40 wt %, or at least or about 45 wt % of the total sensory modifier. In further aspects, the acid fraction comprises less than or about 10 wt %, 15 wt %, 20 wt %, 25 wt %, 30 wt %, 35 wt %, 40 wt %, or less than about 50 wt % of the total sensory modifier. In yet further aspects, the acid fraction comprises 5 wt % to 50 wt %, 10 wt % to 50 wt %, 15 wt % to 50 wt %, 20 wt % to 50 wt %, 5 wt % to 40 wt %, 10 wt % to 40 wt %, 15 wt % to 40 wt %, 20 wt % to 40 wt %, 5 wt % to 35 wt %, 10 wt % to 35 wt %, 15 wt % to 35 wt %, 20 wt % to 35 wt %, 5 wt % to 30 wt %, 10 wt % to 30 wt %, 15 wt % to 30 wt %, 20 wt % to 30 wt %, 5 wt % to 20 wt %, 10 wt % to 20 wt %, 15 wt % to 20 wt %, 5 wt % to 15 wt %, 10 wt % to 15 wt %, or 5 wt % to 10 wt % of the total sensory modifier.

In various aspects, e.g., in an aqueous solution, the salt form of the total sensory modifier exists in equilibrium with the acid form. For example, a particular salt form molecule can become protonated and thus convert into the acid form and an acid form molecule can be come deprotonated to result in a salt form. After approaching or achieving equilibrium, such interplay will not substantially alter the overall wt % of a given form or fraction of the total sensory modifier. For example, a composition having a salt fraction of 50 wt % or more of the total sensory modifier can maintain the same proportions of salt and acid fractions even though the various compounds might exchange from one fraction to another.

There are also cases where the equilibrium between salt and acids forms can shift in response to the addition of components to the composition. For example, addition of buffer solution, salts, acid, or base can shift the equilibrium to favor the salt or acid fraction, and thus alter the wt % of the composition.

In various other aspects, e.g., in a solid composition, the salt form and acid forms can be in a solid state, in which the proportion between salt and acid forms is frozen. It should be understood that, in various aspects, the ratio of the salt fraction to acid fraction in a solid composition, such as a granulated salt composition, can differ from that of a resulting solution to which the solid composition is added. For example, in some aspects, a solid state salt composition will, upon dissolving or disintegrating, result in a solution having a sensory modifier of which at least 50 wt % is in salt form.

### Effective Amount of Sensory Modifier

The compositions of the present disclosure comprise a sensory modifier in an amount effective to reduce plant-protein flavor, reduce off-tases, and/or enhance sourness and lactic flavor in the dairy substitute composition relative to an equivalent dairy substitute composition without the sensory modifier.

As used herein, “plant protein flavor” refers to the characteristic flavor(s) associated with and expected from plant-based proteins when said plant-based proteins are used as ingredients in food and beverage products. For example, plant protein flavors include beany, pea, corny, hay, green notes, vegetative notes, barnyard, fermented, waxy, bitter aftertaste, and combinations thereof that are usually found and expected from a plant-based protein. In general, certain characteristic plant protein flavors can be attributed to certain plant-based proteins. For example, pea proteins may be associated with green notes, pea flavor, and hay flavor; soy proteins may be associated with beany flavor and hay flavor, com proteins may be associated with corny flavor and hay flavor, and potato proteins may be associated with barnyard flavor and fermented flavor.

As used herein, “off-taste(s)” refer to a taste or flavor profile that is not characteristic or usually associated with a substance or composition as described herein and/or a characteristic taste or flavor associated with a substance or composition that is undesirable. For example, the off-taste may be an undesirable taste such as bitterness, undesirable mouthfeel such as astringency, mouth drying, undesirable flavor such as rancid, cardboard, aftertaste, inconsistent flavor (e.g., a flavor with an uneven onset or intensity, a flavor that may be perceived too early or too late), and the like.

A sensory panel can be used to determine the magnitude of reduction in plant-protein flavor or shifts in its temporal profile, thereby quantifying the amount of sensory modifier effective to reduce plant-protein flavor. Sensory panels are a scientific and reproducible method that is essential to the food science industry. A sensory panel involves a group of two or more individual panelists. Panelists are instructed according to industry-recognized practices to avoid the influence of personal subjectivity and strengthen reproducibility. For example, panelists will objectively evaluate sensory attributes of a tested product but will not provide subjective attributes such as personal preference. In various aspects, the sensory panel can be conducted with two, three, four, five, six or more panelists, in which the panelists identify and agree on a lexicon of sensory attributes for a given set of samples. After evaluating a specific sample, the panelists can assign a numerical intensity score for each attribute using an intensity scale. For example, intensity scales can range from 0 to 6 (i.e., 0=not detected, 1=trace, 2=slight, 3=moderate, 4=definite, 5=strong, 6=extreme), 0 to 9 (i.e., 0=not detected, 1=trace, 2=faint, 3=slight, 4=mild, 5=moderate, 6=definite, 7=strong, 8=very strong, 9=extreme), or 0 to 15, where 0 corresponds to the absence of the attribute, while 6, 9, or 15, respectively, corresponds to the upper bound extreme occurrence of the attribute. The panel may use a roundtable consensus approach or the panelists may score and evaluate the sensory attribute(s) individually. Either format can further involve a panel leader who directs the discussion regarding terminology and directs the panel to evaluate particular products and attributes. In other aspects, a trained sensory panel can be utilized to assess specific attributes using descriptive analysis or time intensity methodologies.

As used herein, “panelist” refers to a highly trained expert taster, such as those commonly used for sensory methodologies such as descriptive analysis, and/or an experienced taster familiar with the sensory attribute(s) being tested. In some aspects, the panelist may be a trained panelist. A trained panelist has undergone training to understand the terms and sensory phenomenon associated with those sensory attributes relevant to the tested product and are aligned on the use of common descriptors for those sensory attributes of interest (i.e., a sensory lexicon). For example, a trained panelist testing a given composition will understand the terms and sensory attributes associated with said composition, e.g. saltiness, sourness, bitterness, astringency, mouthfeel, acidity, and the like. The trained panelist will have been trained against reference samples corresponding to the sensory attributes being tested and thus have calibrated to recognize and quantitatively assess such criteria. In some aspects, the panelist may be an experienced taster.

As used herein, “roundtable consensus approach” refers to the sensory panel assay methodology wherein panelists discus sensory attributes and intensities before mutually agreeing on an intensity score and attribute characterization for the particular sensory attribute(s) being assayed. A sensory panel using a roundtable consensus approach may include 2, 3, 4, 5, 6, or more panelists. Consensus intensity scales can range from 0 to 6 (i.e., 0=not detected, 1=trace, 2=slight, 3=moderate, 4=definite, 5=strong, 6=extreme) or 0 to 9 (i.e., 0=not detected, 1=trace, 2=faint, 3=slight, 4=mild, 5=moderate, 6=definite, 7=strong, 8=very strong, 9=extreme). For a given set of samples, the panelists will identify and agree on a lexicon of sensory attribute, including, if applicable, reference or standardized samples (also referred to as sensory anchors) for a particular sensory attribute. The reference sample(s) used for a given sensory attribute(s) will depend on the samples being assayed and the lexicon of sensory attributes determined by the panel. One of skill in the art will recognize the appropriate lexicon and reference or standard samples necessary for sensory assessment of a given sample(s).

In some aspects, the samples are scored and evaluated by panelists independently after panelists have agreed upon or been instructed in a lexicon of sensory attributes and intensity scores including, if applicable, assay specific calibration on reference samples (also referred to as sensory anchors) for a particular sensory attribute. Examples of common reference samples are described below. Panelists may evaluate samples in replicate and may be blinded to the samples they are testing. Samples being tested may be provided to the panelists randomly or in a sequential order. In some aspects, samples may be tested by panelists using a randomized balanced sequential order. Scores from individual panelists are then assessed using standard statistical analysis methods to determine an average sensory intensity score. One of skill in the art will recognize the appropriate lexicon and reference or standard samples necessary for sensory assessment of a given sample(s) as well as the appropriate statistical analysis methods.

As used herein, “randomized balanced sequential order” refers to the order in which samples are presented in which the order is randomized but across all panelists all possible orders of the samples will be presented to remove bias for the samples being tested in a particular order. For example, for a randomized balanced sequential order of two samples, there would be an equal likelihood that a given panelist receives sample 1 before sample 2 and sample 2 before sample 1. In an example with three samples (i.e., samples 1, 2, and 3), a randomized balanced sequential order would include an equal likelihood that panelists receiving samples in the following orders: (i) 1, 2, 3; (ii) 1, 3, 2; (iii) 2, 1, 3; (iv) 2, 3, 1; (v) 3, 2, 1; (vi) 3, 1, 2.

A sensory attribute(s) of a given composition may be evaluated in comparison to one or more reference or anchor samples. For example, sodium chloride solutions can be used by experienced panelists as saltiness anchors to assess the relative intensity of saltiness for a given composition; sucrose solutions can be used by experienced panelists as sweetness anchors to assess the relative intensity of sweetness for a given composition; citric acid solutions can be used by experienced panelists as sourness anchors to assess the relative intensity of sourness for a given composition; coffee solutions can be used by experienced panelists as bitterness anchors to assess the relative intensity of bitterness for a given composition; and monosodium glutamate (MSG) solutions can be used by experienced panelists as umami anchors to assess the relative intensity of umami for a given composition. Experienced panelists can be presented with a solution to assess sensory attributes, e.g., 10-20 mL of a sample. Panelists will dispense approximately 3-4 mL of each solution into their own mouths, disperse the solution by moving their tongues, and record a value for the particular sensory attribute being tested. If multiple solutions are to be tested in a session, the panelists may cleanse their palates with water between samples. For example, a roundtable assessment of saltiness, sweetness, sourness, umami, and the like can assign a scale of 0 to 9 with, e.g., a score of 0 indicating no saltiness and a score of 9 indicating extreme saltiness (0=not detected, 1=trace, 2=faint, 3=slight, 4=mild, 5=moderate, 6=definite, 7=strong, 8=very strong, 9=extreme). Equivalent scales and methodologies can be used for sweet, bitter, sour, and umami sensory attributes.

As a further example, saltiness of a composition can be tested by a panel of at least two panelists. The panelists can use a standard range of 0.18% (wt), 0.2% (wt), 0.35% (wt), 0.5% (wt), 0.567% (wt), 0.6% (wt), 0.65% (wt), and 0.7% (wt) sodium chloride solutions in water corresponding to a saltiness intensity value of 2, 2.5, 5, 8.5, 10, 11, 13, and 15, respectively. A skilled artisan will recognize that depending on the sample/composition being tested, the number and range of standard solutions may be changed (e.g., using only the solutions corresponding to the 2, 2.5, and 5 saltiness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a saltiness intensity value between 0 and 15 for each composition based on comparison to the aforementioned standard sodium chloride solutions. Between tasting compositions, the panelists are able to cleanse their palates with water. The panelists also can taste the standard 0.18%, 0.2%, 0.35%, 0.5%, 0.567%, 0.6%, 0.65%, and 0.7% sodium chloride solutions ad libitum between tasting test solutions to ensure recorded saltiness intensity values are accurate against the scale of the standard sodium chloride solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Saltiness Intensity Test.”

Sourness of a composition can be tested by a panel of at least two panelists. The panelists can use a standard range of 0.035% (wt), 0.05% (wt), 0.07% (wt), 0.15% (wt), and 0.2% (wt) citric acid solutions in water corresponding to a sourness intensity value of 2, 3, 5, 10, and 15, respectively. A skilled artisan will recognize that depending on the sample/composition being tested, the number and range of standard solutions may be changed (e.g., using only the solutions corresponding to the 2 and 7 sourness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a sourness intensity value between 0 and 15 for each composition based on comparison to the aforementioned standard citric acid solutions. Between tasting compositions, the panelists are able to cleanse their palates with water. The panelists also can taste the standard 0.035%, 0.05%, 0.07%, 0.15%, and 0.2% citric acid solutions ad libitum between tasting test solutions to ensure recorded sourness intensity values are accurate against the scale of the standard citric acid solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sourness Intensity Test.”

Bitterness of a composition can be tested by a panel of at least two panelists. The panelists can use a standard range of 0.0125% (wt), 0.01875% (wt), 0.025% (wt), 0.031% (wt), 0.07% (wt), and 0.12% (wt) caffeine solutions in water corresponding to a bitterness intensity value of 2, 3, 4, 5, 10, and 15, respectively. A skilled artisan will recognize that depending on the sample/composition being tested, the number and range of standard solutions may be changed (e.g., using only the solutions corresponding to the 2, 3, and 5 bitterness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a bitterness intensity value between 0 and 15 for each composition based on comparison to the aforementioned standard caffeine solutions. Between tasting compositions, the panelists are able to cleanse their palates with water. The panelists also can taste the standard 0.0125%, 0.01875%, 0.025%, 0.031%, 0.07%, and 0.12% caffeine solutions ad libitum between tasting test solutions to ensure recorded bitterness intensity values are accurate against the scale of the standard caffeine solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Bitterness Intensity Test.”

Sweetness of a composition can be tested by a panel of at least two panelists. The panelists can use a standard range of 2% (wt), 5% (wt), 8% (wt), 10% (wt), and 15% (wt) sucrose solutions corresponding to a sweetness intensity value of 2, 5, 8, 10, and 15, respectively. A skilled artisan will recognize that depending on the sample/composition being tested, the number and range of standard solutions may be changed (e.g., using only the solutions corresponding to the 2, 5, and 8 sweetness intensity values). For each test composition, the panelists dispenses approximately 2-5 mL, for liquid compositions or solutions prepared with water, or 5-10 g, for solid compositions, of each composition into their own mouths, disperses the composition by moving their tongues/chewing, and records a sweetness intensity value between 0 and 15 for each composition based on comparison to the aforementioned standard sucrose solutions. Between tasting compositions, the panelists are able to cleanse their palates with water. The panelists also can taste the standard 2%, 5%, 8%, 10%, and 15% sucrose solutions ad libitum between tasting test solutions to ensure recorded sweetness intensity values are accurate against the scale of the standard sucrose solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sweetness Intensity Test.”

Umami of a composition can be tested by a panel of at least two panelists. The panelists can use a standard range of 0.75% (wt) and 0.125% (wt) monosodium glutamate (MSG) solutions corresponding to an umami intensity value of 4 and 6.5, respectively. A skilled artisan will recognize that depending on the sample/composition being tested, the number and range of standard solutions may be changed (e.g., adding additional umami solutions if the umami intensity is expected to be appreciably outside of the umami intensity value of 4-6.5). For each test composition, the panelists dispenses approximately 2-5 mL, for liquid compositions or solutions prepared with water, or 5-10 g, for solid compositions, of each composition into their own mouths, disperses the composition by moving their tongues/chewing, and records an umami intensity value between 0 and 15 for each composition based on comparison to the aforementioned standard MSG solutions. Between tasting compositions, the panelists are able to cleanse their palates with water. The panelists also can taste the standard 0.075% and 0.125% MSG solutions ad libitum between tasting test solutions to ensure recorded umami intensity values are accurate against the scale of the standard MSG solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Umami Intensity Test.”

A control sample is typically used as a reference point or for comparison purposes. For example, a control sample can be used to qualify the effectiveness of a sensory modifier. The control sample can be a composition such as a composition as described herein, but without the presence of the sensory modifier. Other than the sensory modifier, the control sample is otherwise the same, and it should contain the same component(s) and other ingredients at the same relative concentrations. Other standard samples are commonly used in sensory panels, for example standard samples used to evaluate intensity of sensory attributes as outlined above. In other aspects, the control sample may be a modified control sample which contains a different sensory modifier such as a competitor sensory modifier.

This disclosure is not limited to sensory testing by experienced or trained panelists. For example, it is possible to utilize untrained and inexperienced panelists. However, in the case of untrained and inexperienced panelists, a greater number of these panelists is usually necessary to provide reproducible results, which will typically focus on subjective attributes such as preference or overall liking. Similarly, untrained and inexperienced panelists may be asked to evaluate relative changes in a given sensory attribute between two samples. For example, if a particular sample is more or less salty, more or less sweet, more or less bitter, etc., than a reference sample.

An exemplified sensory assay and test criteria for further sensory attributes are described in the Examples provided in this disclosure. Additional description regarding roundtable sensory panels and sensory testing is set forth in PCT/US2018/054743, published Apr. 11, 2019 as WO 2019/071220, which is incorporated by reference herein in its entirety.

In some aspects, the amount of sensory modifier effective to decrease plant protein flavor can be the amount effective to reduce plant protein flavor intensity score by at least 0.5, 1, 1.5, 2, or at least 2.5 units relative to plant protein flavor intensity in an equivalent composition lacking the sensory modifier. The plant protein flavor intensity score is determined by at least three panelists trained in tasting plant protein compositions using a roundtable methodology using a scale of 0 to 9, where a score of 0 indicates no plant protein flavor and 9 indicates extreme plant protein flavor intensity (i.e., 0=not detected, 1=trace, 2=faint, 3=slight, 4=mild, 5=moderate, 6=definite, 7=strong, 8=very strong, 9=extreme). In some aspects, the plant protein flavor may be reduced by at least 2, at least 3, or at least 4 units. In some aspects, the plant protein flavor intensity may be evaluated by assaying beany, pea, corny, hay, green notes, barnyard, fermented, or waxy flavor intensity, where a decrease in beany, pea, corny, hay, green notes, barnyard, fermented, or waxy flavor intensity, respectively, demonstrates a decrease in plant protein flavor intensity. Similar evaluation processes may be used to score other sensory attributes of the dairy composition described herein.

In some aspects, the amount of sensory modifier effective to decrease plant protein flavor can be the amount effective to reduce plant protein flavor intensity score by at least 0.5, 1, 1.5, 2, or at least 2.5 units relative to plant protein flavor intensity in an equivalent composition lacking the sensory modifier. The plant protein flavor intensity score is determined as the average plant protein flavor intensity score from at least seven panelists, trained in sensory evaluation, upon randomized balanced sequential order evaluation of samples using a scale of 0 to 15, where a score of 0 indicates no plant protein flavor and 15 indicates extreme plant protein flavor intensity. In some aspects, the plant protein flavor may be reduced by at least 2, at least 3, or at least 4 units. In some aspects, the plant protein flavor intensity may be evaluated by assaying beany, pea, corny, hay, green notes, barnyard, fermented, or waxy flavor intensity, where a decrease in beany, pea, corny, hay, green notes, barnyard, fermented, or waxy flavor intensity, respectively, demonstrates a decrease in plant protein flavor intensity. Similar evaluation processes may be used to score other sensory attributes of the dairy composition described herein.

In some aspects, the amount of sensory modifier effective to increase sourness can be the amount effective to increase a sourness intensity value, measured by the Standardized Sourness Intensity Test with at least four panelists experienced in sensory testing, by at least 1 unit. In other aspects, the amount effective to increase sourness comprises an amount effective to increase a sourness intensity value, measured the same way, by at least 1 unit, 2 units, 3 units, 4 units, 5 units, 6 units, or more. In other aspects, the amount effective to increase sourness comprises an amount effective to increase a sourness intensity value, measured the same way, to above 2, 3, 4, 5, 6, or 7 units. Similar test may be used to evaluate the amount of sensory modifier effective to decrease or increase in sweetness, saltiness, bitterness, and umami in the described dairy substitute compositions.

The dairy substitute compositions can have various amounts of sensory modifier. Sensory modifier can be present in the dairy substitute composition in any amount desired for the particular use. For example, the sensory modifier can be present in the dairy substitute composition at a total concentration from 0.001% (wt) to 1.0% (wt), 0.001% (wt) to 0.5% (wt), 0.005% (wt) to 0.1% (wt), 0.005% (wt) to 0.050% (wt), or 0.005% (wt) to 0.02% (wt). The dairy substitute composition may include the sensory modifier at a concentration of at least 0.001%, 0.002%, 0.005%, 0.01%, 0.02%, or 0.05% by weight of the dairy substitute composition. The dairy substitute composition may include the sensory modifier at a concentration up to 1.0% (wt), 0.5% (wt), 0.25% (wt), 0.2% (wt), 0.1% (wt), or 0.05% (wt).

The amount of an individual sensory modifier species in the various compositions described herewith can each independently vary. For example, monocaffeoylquinic acid, dicaffeoylquinic acid, or both, can each individually be present in the dairy substitute composition at a concentration from about 1 ppm to about 1000 ppm. In some aspects, monocaffeoylquinic acid, dicaffeoylquinic acid, or both, can each individually be present in the dairy substitute composition at a concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, 900 ppm to about 1000 ppm. In some aspects, monocaffeoylquinic acid, dicaffeoylquinic acid, or both, can each individually be present at a concentration of or greater than about 10, 50, 100, 200, 300, 400, 500, 600, 700, 800, 900, or 1000 ppm in the dairy substitute composition. In some aspects, monocaffeoylquinic acid, dicaffeoylquinic acid, or both, can each individually be present in the met substitute composition at a concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, monocaffeoylquinic acid, dicaffeoylquinic acid, or both, can each individually be present in the dairy substitute composition at a concentration from about 400 ppm to about 800 ppm.

### Botanical Source of Sensory Modifier

In various aspects, the sensory modifier can be isolated from botanical sources. Various botanical sources comprise sensory modifiers and sensory modifiers can be isolated from these botanical sources. Some examples of botanical sources from which sensory modifiers can be isolated include Eucommia ulmoides, honeysuckle, Nicotiana benthamiana, artichoke, globe artichoke, cardoon, Stevia rebaudiana, monkfruit, coffee, coffee beans, green coffee beans, tea, white tea, yellow tea, green tea, oolong tea, black tea, red tea, post-fermented tea, bamboo, heather, sunflower, blueberries, cranberries, bilberries, grouseberries, whortleberry, lingonberry, cowberry, huckleberry, grapes, chicory, eastern purple coneflower, echinacea, Eastern pellitory-of-the-wall, Upright pellitory, Lichwort, Greater celandine, Tetterwort, Nipplewort, Swallowwort, Bloodroot, Common nettle, Stinging nettle, Potato, Potato leaves, Eggplant, Aubergine, Tomato, Cherry tomato, Bitter apple, Thom apple, Sweet potato, apple, Peach, Nectarine, Cherry, Sour cherry, Wild cherry, Apricot, Almond, Plum, Prune, Holly, Yerba mate, Mate, Guayusa, Yaupon Holly, Kuding, Guarana, Cocoa, Cocoa bean, Cacao, Cacao bean, Kola nut, Kola tree, Cola nut, Cola tree, Ostrich fern, Oriental ostrich fern, Fiddlehead fem, Shuttlecock fern, Oriental ostrich fern, Asian royal fern, Royal fern, Bracken, Brake, Common bracken, Eagle fem, Eastern brakenfem, Clove, Cinnamon, Indian bay leaf, Nutmeg, Bay laurel, Bay leaf, Basil, Great basil, Saint-Joseph's-wort, Thyme, Sage, Garden sage, Common sage, Culinary sage, Rosemary, Oregano, Wild marjoram, Marjoram, Sweet marjoram, Knotted marjoram, Pot marjoram, Dill, Anise, Star anise, Fennel, Florence fennel, Tarragon, Estragon, Mugwort, Licorice, Liquorice, Soy, Soybean, Soyabean, Soya vean, Wheat, Common wheat, Rice, Canola, Broccoli, Cauliflower, Cabbage, Bok choy, Kale, Collard greens, Brussels sprouts, Kohlrabi, Winter's bark, Elderflower, Assa-Peixe, Greater burdock, Valerian, and Chamomile.

Some botanical sources may produce sensory modifiers that are enriched for one or more of caffeic acid, monocaffeoylquinic acids, and dicaffeoylquinic acids. For example, sensory modifiers isolated from yerba mate plant (Ilex paraguariensis) are enriched for monocaffeoylquinic and dicaffeoylquinic acids. In other aspects, sensory modifiers isolated from yerba mate plant that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic, 3,5-dicaffeoylquinic acid, and 4,5-dicaffeoylquinic acid, and salts thereof. For example, sensory modifiers isolated from other botanical sources can be enriched for dicaffeoylquinic acids. In other aspects, sensory modifiers isolated from other botanical sources that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and salts thereof.

Sensory modifier may be isolated in a variety of ways. Some suitable processes are disclosed in more detail in U.S. application Ser. No. 16/373,206, filed Apr. 4, 2019 and entitled “Steviol Glycoside Solubility Enhancers,” which was published on Jul. 25, 2019 as US Patent Application Publication No. 2019/0223481; International Application No. PCT/US2018/054691, filed Oct. 5, 2018 and entitled “Steviol Glycoside Solubility Enhancers;” U.S. Provisional Application No. 62/569,279, filed Oct. 6, 2017, and entitled “Steviol Glycoside Solubility Enhancers;” U.S. application Ser. No. 16/374,894, filed Apr. 4, 2019 and entitled “Methods for Making Yerba Mate Composition,” which was published on Aug. 1, 2019 as US Patent Application Publication No. 2019/0231834; International Application No. PCT/US2018/054688, filed Oct. 5, 2018 and entitled “Methods for Making Yerba Mate Composition;” U.S. Provisional Application Ser. No. 62/676,722, filed May 25, 2018, and entitled “Methods for Making Yerba Mate Extract Composition;” and International Application No. PCT/US2020/026885 filed Apr. 6, 2020, entitled “Stevia Processing,” and published as WO 2020/210161 on Oct. 15, 2020, each of which is incorporated herein by reference. For example, sensory modifier may be isolated from a botanical source that comprises one or more of monocaffeoylquinic acid, dicaffeoylquinic acid, and salts thereof. For example, yerba mate biomass and stevia biomass can be used to prepare sensory modifier. In one exemplary process, sensory modifier is prepared from commercially obtained comminuted yerba mate biomass. Briefly, yerba mate biomass is suspended in 50% (v/v) ethanol/water, shaken for at least 1 hour, and the resulting mixture filtered to obtain an initial extract. The initial extract is diluted to 35% (v/v) ethanol with water and refiltered. Refiltered permeate is then applied to a column of AMBERLITE® FPA 53 resin that has been equilibrated in 35% (v/v) ethanol/water and the column permeate is discarded. The column is washed with 35% (v/v) ethanol/water and the column permeate is discarded. The column is then eluted with 10% (w/v) FCC grade sodium chloride in 50% (v/v) ethanol/water and the eluent retained. Nitrogen gas is blown at room temperature over a surface of the eluent to remove ethanol and reduce the eluent to 1/3 of its original volume. The reduced volume eluent is then filtered through a 0.2 μm polyethersulfone filter and then decolored by passing through a 3 kDa molecular weight cutoff membrane. The decolored permeate is retained and desalted by passing through a nanofiltration membrane. The desalted permeate is then freeze-dried to obtain the sensory modifier. This process is also suitable to obtain sensory modifier from stevia biomass and can be adapted to obtain sensory modifier from other botanical sources for example those described above.

In some aspects, the sensory modifier can be a blend of sensory modifier isolated from more than one botanical source.

Some compounds can adversely impact flavor or aroma of an aqueous solution or dairy substitute composition. Certain sensory modifiers, such as those prepared from plant extract do not include one or more of the compounds shown in Table 2, or any combination thereof, above the disclosed preferred content levels. All preferred content levels are stated as weight percent on a dry weight basis. Certain commercially desirable solid (dry) sensory modifiers do not include more than the preferred level of any of the compounds listed in Table 2. For those compounds listed that are acids, the compound may be present in acid form and/or in slat form.

TABLE 2

| | Preferred | % wt of compounds in steviol |
|---|---|---|
| Class of | Content | glycoside solubility enhancer |
| compounds | Level (% wt) | solid (dry) compositions |
| Organic acids | <3%, preferably | malonate, malonic acid, |
| | <2%, <1%, or 0% | oxalate, oxalic acid, |
| | | lactate, lactic acid, |
| | <0.5%, preferably | succinate, succinic acid, |
| | <0.25% or 0% | malate, malic acid, citrate, |
| | | citric acid tartrate, tartaric |
| | | acid, pyruvate, pyruvic acid, |
| | | fumarate, fumaric acid, |
| | | ascorbic acid, sorbate, sorbic |
| | | acid, acetate, acetic acid |
| Inorganic acids | <1%, preferably | sulfate, sulfuric acid, |
| | <0.5% or 0% | phosphate, phosphoric |
| | | acid, nitrate, nitric acid, |
| | | nitrite, nitrous acid, |
| | | chloride, hydrochloric |
| | | acid, ammonia, |
| | | ammonium |
| Flavanoids, | <5%, preferably | quercetin, kaempferol, |
| isoflavanoids, | <4%, <3%, or <2%, | myricetin, fisetin, galangin, |
| and | more preferably | isorhamnetin, pachypodol, |
| neoflavanoids | <1%, <0.5%, or 0% | rhamnazin, pyranoflavonols, |
| | | furanoflavonols, luteolin, |
| | | apigenin, tangeritin, taxifolin |
| | | (or dihydroquercetin), |
| | | dihydrokaempferol, |
| | | hesperetin, naringenin, |
| | | eriodictyol, homoeriodictyol, |
| | | genistein, daidzein, glycitein |
| Flavanoid | <5%, preferably | hesperidin, naringin, rutin, |
| glycosides | <4%, <3%, or <2%, | quercitrin, luteolin- |
| | more preferably | glucoside, quercetin- |
| | <1%, <0.5%, or 0% | xyloside |
| Anthocyanidins | <5%, preferably | cyanidin, delphinidin, malvidin, |
| | <4%, <3%, or <2%, | pelargonidin, peonidin, petunidin |
| | more preferably | |
| | <1%, <0.5%, or 0% | |
| Tannins | <1%, preferably | tannic acid |
| | <0.5%, <0.25%, or | |
| | 0% | |
| Amino acids + | <0.1%, preferably | alanine, arginine, asparagine, |
| total protein | <0.05%, or 0% | aspartic acid, cysteine, |
| | | glutamine, glutamic acid, |
| | | glycine, histidine, isoleucine, |
| | | leucine, lysine, methionine, |
| | | phenylalanine, proline, serine, |
| | | threonine, tryptophan, |
| | | tyrosine, and valine |
| Total Fat | <1%, preferably | monoglycerides, diglycerides, |
| | <0.5%, <0.25%, or | triglycerides |
| | 0% | |
| Monosaccharides, | <1% | glucose, fructose, sucrose, |
| disaccharides, and | | galactose, ribose, trehalose, |
| polysaccharides | | trehalulose, lactose, maltose, |
| | | isomaltose, isomaltulose, |
| | | mannose, tagatose, |
| | | arabinose, rhamnose, |
| | | xylose, dextrose, erythrose, |
| | | threose, maltotriose, panose |
| Sugar alcohols | <1% | glycerol, sorbitol, mannitol, |
| | | xylitol, maltitol, lactitol, |
| | | erythritol, isomalt, inositol |
| Dietary fiber | <0.1%, preferably | acacia (arabic) gum, agar-agar, |
| | <0.05% or 0% | algin-alginate, arabynoxylan, |
| | | beta-glucan, beta mannan, |
| | | carageenan gum, carob or locust |
| | | bean gum, fenugreek gum, |
| | | galactomannans, gellan gum, |
| | | glucomannan or konjac gum, |
| | | guar gum, hemicellulose, |
| | | inulin, karaya gum, pectin, |
| | | polydextrose, psyllium husk |
| | | mucilage, resistant starches, |
| | | tara gum, tragacanth gum, |
| | | xanthan gum, cellulose, |
| | | chitin, and chitosan |
| Steviol glycoside | <55% | stevioside; steviolbioside; |
| compounds | | rubusoside; 13- and 19-SMG; |
| | | dulcosides A, B, C, D; and |
| | | rebaudiosides A, B, C, D, |
| | | E, F, I, M, N, O, T |
| Saponins | <2%, preferably | glycosylated ursolic acid |
| | <1%, <0.5%, | and glycosylated |
| | <0.25%, or 0% | oleanolic acid |
| Terpenes other | <2%, preferably | eugenol, geraniol, geranial, |
| than saponins and | <1%, <0.5%, | alpha-ionone, beta-ionone, |
| steviol glycoside | <0.25%, or 0% | epoxy-ionone, limonene, |
| compounds | | linalool, linalool oxide, |
| | | nerol, damascenone |
| Lipid oxidation | <2%, preferably | Decanone, decenal, nonenal, |
| products | <1%, <0.5%, | octenal, heptenal, hexenal, |
| | <0.25%, or 0% | pentenal, pentenol, pentenone, |
| | | hexenone, hydroxynonenal, |
| | | malondialdehyde |
| Polycyclic | <0.1%, preferably | Acenaphthene, |
| Aromatic | <0.05% or 0% | Acenaphthylene, |
| Hydrocarbons | | Anthracene, |
| | | Benzo(a)anthracene, |
| | | Benzo(a)pyrene, |
| | | Benzo(b)fluoranthene, |
| | | Benzo(ghi)perylene, |
| | | Benzo(k)fluoranthene, |
| | | Chrysene, |
| | | Dibenzo(a,h)anthracene, |
| | | Fluoranthene, Fluorene, |
| | | Indeno(1,2,3-cd)pyrene, |
| | | Naphthalene, |
| | | Phenanthrene, Pyrene |
| Other | <0.1%, preferably | chlorophyll, furans, furan- |
| compounds | <0.05% or 0% | containing chemicals, |
| | <1%, preferably | theobromine, theophylline, |
| | <0.5%, <0.25%, | and trigonelline |
| | or 0% | saponins |

In some aspects, the sensory modifier comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

In some aspects, a dairy substitute composition described does not include certain compound above a certain cutoff wt %. For example, the aqueous solution can comprise less than 0.3% (wt) of malonate, malonic acid, oxalate, oxalic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll, depending on the dairy substitute composition.

The present invention can be better understood by reference to the following examples which are offered by way of illustration. The present invention is not limited to the examples given herein.

### EXAMPLES

### Materials and Methods

The tested sensory modifier was a mixture of monocaffeoylquinic and dicaffeoylquinic acids and salts prepared from yerba mate and having a ratio of salt fraction to acid fraction of 65:35. For some of the compositions, the sensory modifier was co-spray dried with a steviol glycoside. Table 3 lists the contents and source of various components.

TABLE 3

| Component | Ingredients | Source |
|---|---|---|
| Sensory | Mixture containing mono- | Cargill, Inc. |
| Modifier | and dicaffeoylquinic acids and | (Wayzata, MN) |
| | salts, prepared from Yerba mate | |
| | 65:35 ratio of salt:acid from | |

### Plant Protein Assay

Assays were carried out to characterize the sensory attributes of plant-protein isolate solutions with various amounts of sensory modifier. Sensory attributes of the compositions were tested by a panel of individuals that are experienced in sensory testing. The experienced panelists assessed sensory attributes such as, but not limited to, bean flavor, hay flavor, mouth drying, creaminess, green pea flavor, bitterness, oil notes, corn flavor, starchy, barnyard flavor, sour, and astringency. Sensory attributes were scored on a scale of 0-9 with 0 indicating no sensory attribute intensity and 9 indicating an extreme sensory attribute intensity (i.e., 0=not detected, 1=trace, 2=faint, 3=slight, 4=mild, 5=moderate, 6=definite, 7=strong, 8=very strong, 9=extreme). In some Examples, a roundtable methodology was used to assess various flavor attributes. To test each composition, the experienced panelists dispensed approximately 2-4 fl oz of each solution into their own mouths, dispersed the solution by moving their tongues, and recorded a consensus sensory attribute scale value. Between tasting solutions, the panelists were able to cleanse their palates with water.

Assays in which a particular methodology or panel were used are noted in the individual examples below.

### Example 1—Plant-Based Cheese Substitute

Plant-based cheese was prepared with the ingredients outlined in Table 4. To prepare the plant-based cheese, the water was added to a blender and heated to about 110° F. (43.3° C.). Hydrocolloids, including the guar gum and carrageenan but excluding the lecithin, were added to the heated water and stirred for 2-5 minutes. Protein was then added and mixed for an additional 2 to 3 minutes. Following the addition of protein, the dry ingredients, including starches, salt, trisodium citrate, citric acid, and flavoring (where applicable), but excluding lecithin, were added with continued mixing. Separately, the oil was heated to 50° C. and the lecithin was added thereto. The oil and lecithin mixture was slowly added to the water based mixture. Upon combination of the oil and water mixture, the mixing speed of the blender was increased, and the mixture was further heated to 180° F. (82.2° C.) and held at that temperature for about 3 minutes. Following the final heating, the product was placed in a container in a blast freezer for 5 to 10 minutes. Following freezing, the plant-based cheese product is stored at 4° C. The sensory modifier was added with the dry ingredients were applicable.

TABLE 4

| | Sample (wt % Sensory Modifier) | | | |
|---|---|---|---|---|
| | | 1.2 | 1.3 | 1.4 |
| Ingredient* | 1.1 | (0.01%) | (0.015%) | (0.02%) |
| Water | 57.1082 | 58.1022 | 58.0972 | 58.0921 |
| Pea protein isolate | 6.5261 | 6.5261 | 6.5261 | 6.5261 |
| Coconut Oil | 17.0682 | 17.0682 | 17.0682 | 17.0682 |
| Trisodium citrate | 0.1205 | 0.1205 | 0.1205 | 0.1205 |
| dihydrate | | | | |
| Salt (NaCl) | 1.5060 | 1.5060 | 1.5060 | 1.5060 |
| De-oiled lecithin | 1.1044 | 1.1044 | 1.1044 | 1.1044 |
| Citric acid | 0.0004 | 0.0004 | 0.004 | 0.0004 |
| Guar gum | 0.8785 | 0.8785 | 0.8785 | 0.8785 |
| Sensory modifier | — | 0.0100 | 0.0151 | 0.0201 |
| Pregelatinized corn | 8.0321 | 7.0281 | 7.0281 | 7.0281 |
| starch | | | | |
| Modified corn starch | 5.0201 | 5.0201 | 5.0201 | 5.0201 |
| Carrageenan | 2.6355 | 2.6355 | 2.6355 | 2.6355 |

*All values provided as wt %

### Example 2—Sensory Assessment of Plant-Based Cheese

Assays were carried out to characterize the sensory attributes of cheese substitute compositions with various amounts of sensory modifier. Sensory attributes of the compositions were tested by a panel of four individuals that are experienced in sensory testing. The experienced panelists assessed sensory attributes including, but not limited to, plant protein flavor, chewiness, bitterness, saltiness, mouth drying, and creaminess using a roundtable methodology. To test each composition, the experienced panelists dispensed approximately 7 g of each composition into their own mouths, dispersed the composition by chewing and moving their tongues, and recorded a value or comments for the attribute(s) being tested. Between tasting compositions, the panelists were able to cleanse their palates with water. Sensory attributes were assayed the same day, 6 days after, and 1 month after the plant-based cheese was prepared. Sensory attribute results as outlined in Table 5.

TABLE 5

| Sample | Same Day | 6 Days | 1 Month |
|---|---|---|---|
| 1.1 | Noticeable | Chewy, significant pea | |
| | plant | protein flavor, noticeable | |
| | protein | back end bitterness, | |
| | flavor | earthy plant protein | |
| | | notes, delayed salt | |
| | | flavor, mouth drying | |
| 1.2 | Significant | Cleaner than 1.1, much | Flavor modification |
| (0.01%) | reduction | mellower, faint bitterness, | effects less apparent |
| | in plant | similar mild taste | than at day 6, but |
| | protein | to that of string cheese, | still present |
| | flavor | consistent saltiness, | |
| | | sweet cream like finish, | |
| | | no mouth drying | |
| 1.3 | Delayed | Better flavor than | Best overall clean |
| (0.015%) | onset but | 1.1, and similar | flavor, best |
| | reduction | flavor to 1.2, less | at reducing |
| | in plant | bitter, more mouth | pea protein |
| | protein | drying than 1.2, but less | after taste |
| | flavor | mouth drying than 1.1 | |
| 1.4 | Delayed | Savory finish, flour like | |
| (0.02%) | onset but | characteristic, and more | |
| | reduction | mouthdrying | |
| | in plant | than 1.2 or 1.3 | |
| | protein | | |
| | flavor | | |

### Example 3—Sensory Assessment of Plant-Protein Cheese Samples

Assays were carried out to characterize the sensory attributes, including salt taste, sour taste, umami tase, lactic flavor, pulse flavor, and sour after tase, of the plant-based cheese samples described in Table 6. The method outlined in Example 1 was also used to prepare the samples described here. Assays were carried out 3 weeks after preparation of the plant-based cheese.

TABLE 6

| | Sample (wt % Sensory Modifier) | |
|---|---|---|
| Ingredient* | 3.1 | 3.2 (0.02%) |
| Water | 55.875 | 55.205 |
| Pea protein isolate | 7.000 | 7.00 |
| Coconut Oil | 18.000 | 18.00 |
| Salt (NaCl) | 1.500 | 1.50 |
| De-oiled lecithin | 1.125 | 1.125 |
| Sensory modifier | — | 0.020 |
| Pregelatinized corn starch | 8.000 | 8.000 |
| Modified corn starch | 5.000 | 5.000 |
| Carrageenan | 1.500 | 1.500 |
| Acid Concentrate | 0.800 | 1.450 |
| (lactic and citric solution) | | |
| Cheese flavor | 1.080 | 1.080 |
| Butter flavor | 0.120 | 0.120 |

*All values provided as wt %

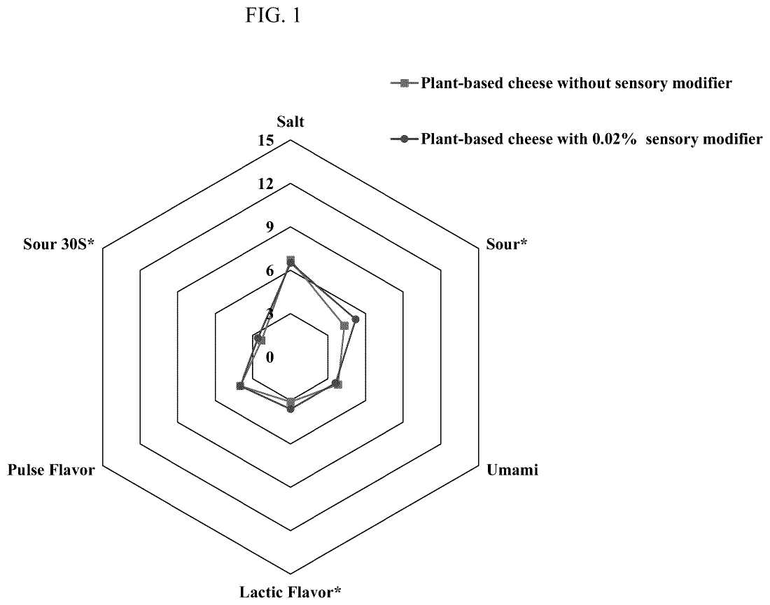

All sensory attributes were scored on a scale of 1-15, with 1 indicated no intensity and 15 indicating strong intensity. Prior to the assays, 9 highly trained and experienced external taste panelists received training on standardized samples (sodium chloride solutions as salt standards, citric acid solutions as sour standards, and MSG solutions as umami standards) using the 1-15 scale. The attribute identities used for each of the sensory attributes tested are outlined in Table 7. For the sensory attribute assays, the 9 panelists were given a 10 minutes break in between samples and provided with filtered water and saltine crackers only during breaks. All samples were evaluated in a randomized balanced sequential order, one at a time. Panelists were given approximately 2.5-inch cubes of the plant-based cheese for the assay and each plant-based cheese sample was analyzed in duplicate. Each sensory attribute for each sample was scored individually by panelists and score were evaluated using standard statistical analysis. Sensory attribute assay results are provided in FIG. 1 and Table 8.

TABLE 7

| Modality | Attribute | Definition |
|---|---|---|
| Taste | Salt | Taste common to table salt (NaCl) |
| | Sour | Taste common to citric acid |
| | Umami | Taste common to monosodium |
| | | glutamate (MSG) |
| Flavor | Lactic | The flavor reminiscent of |
| | Flavor | sour milk and yogurt |
| | Pulse | The flavor reminiscent of legumes such |
| | Flavor | as lentils, chick peas, and split peas |

TABLE 8

| Attributes | | 3.1 | | 3.2 (0.02%) | |
|---|---|---|---|---|---|
| Taste | Salt | 6.7 | | 6.5 | |
| | Sour | 4.3 | b | 5.2 | a |
| | Umami | 3.8 | | 3.6 | |
| Flavor | Lactic Flavor | 3.1 | b | 3.6 | a |
| | Pulse Flavor | 4.0 | | 4.0 | |
| Aftertaste 30 s | Sour | 2.3 | b | 2.6 | a |

*Means followed by different letters are significantly different from each other at p ≤ 0.05.
Plant-based cheese sample 3.2, which included 0.02% of the sensory modifier, scored significantly higher for sourness, lactic flavor, and sour aftertaste at 30 s than plant-based cheese sample 3.1, which lacked the sensory modifier.

### Example 4—Sensory Assessment of Soy Protein Isolate Solutions

Assays were carried out to characterize the sensory attributes of soy protein isolate solutions. Bean flavor, hay flavor, mouth drying, and creaminess scores were determined by a panel of four individuals using a roundtable consensus approach. Panelists were experienced in sensory testing. All panelists used the plant protein assay method described above. Soy protein isolate solutions were prepared by mixing the soy protein isolate with water. For the compositions including the sensory modifier, the sensory modifier was added to the water prior to mixing with the soy protein isolate. The soy protein isolate solutions tested are outlined in Table 9 and sensory attribute results are outlined in Table 10.

TABLE 9

| | Samples | | | |
|---|---|---|---|---|
| Ingredient | 4.1 | 4.2 | 4.3 | 4.4 |
| Water | 98.0% | 97.995% | 97.9933% | 97.990% |
| Soy protein isolate | 2.0% | 2.0% | 2.0% | 2.0% |
| Sensory modifier | — | 0.005% | 0.0067% | 0.010% |

TABLE 10

| Sensory | Samples | | | |
|---|---|---|---|---|
| Attribute | 4.1 | 4.2 | 4.3 | 4.4 |
| Bean flavor | 6 | 4.5-5 | 4 | 4 |
| Hay flavor | 3-4 | 3 | 4.5 | 4.5 |
| Mouth drying | 5 | 4 | 5 | 4 |
| Creaminess | — | 2-3 | 1-2 | 1 |
| Comments | Upfront beany | Further | Further | Overall |
| | note, hay flavor | delay in | delay in | more |
| | detected after | onset and | onset and | cohesive |
| | dissipation of | reduction | reduction | flavor |
| | beany note, latent | in | in | profile, |
| | mouth drying | intensity | intensity | faint sour |
| | with trace to | of beany | of beany | note |
| | faint bitterness | note | note | present |

### Example 5—Sensory Assessment of Pea Protein Isolate Solutions

Assays were carried out to characterize the sensory attributes of pea protein isolate solutions. Green pea flavor, bitterness and oil/creamy scores were determined by a panel of three individuals using a roundtable consensus approach. Panelists were experienced in sensory testing. All panelists used the plant protein assay method described above. Pea protein isolate solutions were prepared by mixing the pea protein isolate with water. For the compositions including the sensory modifier, the sensory modifier was added to the water prior to mixing with the pea protein isolate. The pea protein isolate solutions tested are outlined in Table 11 and sensory attribute results are outlined in Table 12.

TABLE 11

| | Samples | | | |
|---|---|---|---|---|
| Ingredient | 5.1 | 5.2 | 5.2 | 5.4 |
| Water | 98.0% | 97.995% | 97.9933% | 97.990% |
| Pea protein isolate | 2.0% | 2.0% | 2.0% | 2.0% |
| Sensory modifier | — | 0.005% | 0.0067% | 0.010% |

TABLE 12

| Sensory | Samples | | | |
|---|---|---|---|---|
| Attribute | 5.1 | 5.2 | 5.3 | 5.4 |
| Green Pea | 6 | 5.5 | 5 | 4 |
| Flavor | | | | |
| Bitterness | 2 | 2 | 1.5 | 4 |
| Oil/Creamy | 3.5 | 2.5 | 1.5-2 | 1-2 |
| Comments | Long | Delayed | Further delay in | Initial bitterness |
| | lasting | onset of | onset of pea | with other |
| | pea | green | flavor, pea flavor | characteristic pea |
| | flavor | pea | has lower | flavor, bitterness |
| | intensity | flavor | intensity with a | more noticeable, |
| | with latent | | shorter time at | more delayed |
| | bitterness | | peak intensity | creamy note |

### Example 6—Sensory Assessment of Corn Protein Isolate Solutions

Assays were carried out to characterize the sensory attributes of corn protein isolate solutions. Corn intensity, starchy, and mouth drying scores were determined by a panel of six individuals using a roundtable consensus approach. Panelists were experienced in sensory testing. All panelists used the plant protein assay method described above. Corn protein isolate solutions were prepared by mixing the corn protein isolate with water. For the compositions including the sensory modifier, the sensory modifier was added to the water prior to mixing with the corn protein isolate. The corn protein isolate solutions tested are outlined in Table 13 and sensory attribute results are outlined in Table 14.

TABLE 13

| | Samples | | | |
|---|---|---|---|---|
| Ingredient | 6.1 | 6.2 | 6.3 | 6.4 |
| Water | 98.0% | 97.995% | 97.9933% | 97.990% |
| Corn protein isolate | 2.0% | 2.0% | 2.0% | 2.0% |
| Sensory modifier | — | 0.005% | 0.0067% | 0.010% |

TABLE 14

| Sensory | Samples | | | |
|---|---|---|---|---|
| Attribute | 6.1 | 6.2 | 6.3 | 6.4 |
| Corn | 6 | 5 | 4 | 4 |
| Intensity | | | | |
| Starchy | 4 | 4 | 4 | 4 |
| Mouth | 4.5 | 4.5 | 4 | 5 |
| Drying | | | | |
| Comments | Initial starchy | More cohesive | Further | More muted |
| | note, transitions | flavor, | reduction | flavor upfront |
| | to corny flavor | consistent | in corn | resulting in |
| | which builds in | corn flavor | flavor | watery |
| | intensity, hay | intensity | intensity | perception, |
| | note also present | throughout, | | slight |
| | at the end, | faint | | sourness at |
| | powdery and | sourness | | the end |
| | gritty mouth feel | at the end | | |

### Example 7—Sensory Assessment of Potato Protein Isolate Solutions

Assays were carried out to characterize the sensory attributes of potato protein isolate solutions. Barnyard flavor, sourness, astringency, and bitterness scores were determined by a panel of five individuals using a roundtable consensus approach. Panelists were experienced in sensory testing. All panelists used the plant protein assay method described above. Potato protein isolate solutions were prepared by mixing the potato protein isolate with water. For the compositions including the sensory modifier, the sensory modifier was added to the water prior to mixing with the potato protein isolate. The potato protein isolate solutions tested are outlined in Table 15 and sensory attribute results are outlined in Table 16.

TABLE 15

| | Samples | | | |
|---|---|---|---|---|
| Ingredient | 7.1 | 7.2 | 7.3 | 7.4 |
| Water | 98.0% | 97.995% | 97.9933% | 97.990% |
| Potato protein isolate | 2.0% | 2.0% | 2.0% | 2.0% |
| Sensory modifier | — | 0.005% | 0.0067% | 0.010% |

TABLE 16

| Sensory | Samples | | | |
|---|---|---|---|---|
| Attribute | 7.1 | 7.2 | 7.3 | 7.4 |
| Barnyard | 4 | 3 | 2 | 2 |
| Sour | 6 | 6 | 5.5 | 5 |
| Astringency | 7 | 7 | 6 | 6 |
| Bitterness | 5 | 4 | 3 | 4 |
| Comments | Immediate | Delay in | Sour note | Further |
| | sourness | sourness | delayed but | delay in |
| | followed by | onset and | also | sourness |
| | barnyard/ | reduction in | broadened, | onset, |
| | fermented | barnyard/ | more | longer |
| | flavor, | fermented | consistent | lasting |
| | strong | flavor, | flavor | barnyard/ |
| | astringency | starchy | overall | fermented |
| | with | flavor and | | flavor in |
| | lingering | mouth coating | | the finish |
| | bitter | present in | | |
| | aftertaste | the finish | | |

### Example 8—Ice Cream

Assays were carried out to characterize the sensory attributes of dairy-free ice cream with various amount of the sensory modifier. Green oat flavor, dry hay flavor, and mouth drying were determined by a panel of three individuals using a roundtable consensus approach. Panelists were experienced in sensory testing. The composition of the dairy-free ice cream is outline in Table 17. The dairy-free ice cream samples were prepared by pre-heating the water phase, which includes water, almond milk, and hydrocolloid, to between 90-100° F. (32.2-37.8° C.). The pea protein is added and hydrated for 10-15 minutes in the pre-heated water phase. Following hydration of the pea protein, the dry ingredients, which include the vegetable glycerin, liquid sugar, lecithin concentrate, and the potassium sorbate are blended and added to the composition. The coconut oil is melted and into the composition. The composition is then homogenized at 2000 psi (1500 psi 1^{st}/500 psi 2^{nd}), pre-heated to 140° F. (60° C.), pasteurized at 185° F. (85° C.) for 30 seconds, then cooled to 40° F. (4.4° C.) and aged overnight. After cooling and aging, the composition is frozen at or below 32° F. (0° C.). For samples that include the sensory modifier, the sensory modifier was added to the composition at the appropriate concentration before freezing. Sensory attribute results of the ice cream composition are outlined in Table 18.

TABLE 17

| | |
|---|---|
| Water | 7.420% |
| Almond milk | 57.600% |
| Coconut oil | 4.300% |
| Liquid sugar (67.5%) | 17.80% |
| Corn syrup solids | 6.00% |
| Pea protein | 4.100% |
| Vegetable glycerin | 1.00% |
| Hydrocolloid and lecithin concentrate | 0.65% |
| (locust bean gum, guar gum, canola lecithin) | |
| Potassium Sorbate | 0.03% |

all values provided as wt %

TABLE 18

| | Samples | | |
|---|---|---|---|
| Sensory | | 150 ppm | 200 ppm |
| Attribute | Control | Sensory Modifier | Sensory Modifier |
| Green Oat | 5 | 4 | 3 |
| Mouth | 3.5 | 3.5 | 5 |
| drying | | | |
| Dry Hay | 2 | — | — |
| Comments | Moderate | Delayed | Delay in |
| | green oat | onset of green | onset of green |
| | flavor, with | oat character | oat character |
| | slight to | and overall | with further |
| | milk mouth drying | reduced green | reduction in green oat |
| | aftertaste, | oat flavor | flavor intensity, |
| | and a faint | intensity | increase |
| | dry hay after tase | | in mouth drying |
| | | | after tase |

### Example 9—Coconut Yogurt

Dairy-free yogurt samples were prepared by preheating the liquid ingredients (coconut cream and water) to 150 F (about 65.6° C.) then adding the dry ingredients and mixing. The mixture is then homogenized at 1000 psi total (500 psi 1^{st}/500 psi 2^{nd}) Following homogenization, the composition is pasteurized at 185 2F (85 2C) for 30 seconds then cooled to 110 F (about 43.3° C.). A “DA YF-L02” culture is added and incubated to a pH between 4.60 and 4.65. Once the desired pH has been reached, the product is mixed, cooled to 50° F. (10° C.) and stored at 4° C. Coconut yogurt compositions with and without sensory modifier are outlined in Tables 19 and 20.

TABLE 19

| | | Sensory | Sensory | Sensory |
|---|---|---|---|---|
| | | Modifier | Modifier | Modifier |
| Ingredient | Control | 100 ppm | 150 ppm | 200 ppm |
| Coconut cream | 66.87% | 66.87% | 66.87% | 66.87% |
| Water | 22.40% | 22.39% | 22.385% | 22.38% |
| Pea protein | 3.00% | 3.00% | 3.00% | 3.00% |
| Corn starch | 2.5% | 2.5% | 2.5% | 2.5% |
| Potato starch | 2.5% | 2.5% | 2.5% | 2.5% |
| Pectin | 0.20% | 0.20% | 0.20% | 0.20% |
| Sucrose | 2.5% | 2.5% | 2.5% | 2.5% |
| Potassium Sorbate | 0.03% | 0.03% | 0.03% | 0.03% |
| Sensory modifier | — | 0.01% | 0.015% | 0.02% |

*all values provided as wt %

TABLE 20

| | | Sensory | Sensory | Sensory |
|---|---|---|---|---|
| | | Modifier | Modifier | Modifier |
| Ingredient | Control | 100 ppm | 150 ppm | 200 ppm |
| Coconut cream | 66.87% | 66.87% | 66.87% | 66.87% |
| Water | 23.40% | 23.39% | 23.385% | 23.38% |
| Pea protein | 3.00% | 3.00% | 3.00% | 3.00% |
| Tapioca starch | 4.0% | 4.0% | 4.0% | 4.0% |
| Pectin | 0.20% | 0.20% | 0.20% | 0.20% |
| Sucrose | 2.5% | 2.5% | 2.5% | 2.5% |
| Potassium Sorbate | 0.03% | 0.03% | 0.03% | 0.03% |
| Sensory modifier | — | 0.01% | 0.015% | 0.02% |

*all values provided as wt %

### Example 10—Almond Yogurt

Dairy-free yogurt samples were prepared by preheating the water to between 90 and 100° F. (32.2-37.8° C.), adding the dry ingredients, and mixing for 10 minutes. After the 10 minutes, the almond cream is added and mixed for an additional 5 minutes. The mixture is then heated to 150° F. (about 65.6° C.) and homogenized at 2000 psi (1500 psi 1^{st}/500 psi 2^{nd}). The homogenized mixture is heated to and held at 185° F. (85° C.) for 5 minutes, then cooled to between 105 and 108° F. (40.5-42.2 C). The culture is added and incubated to a pH between 4.55 and 4.60. If needed, a 50% o citric acid solution may be added to raise pH above 4.45. The product is then mixed, cooled to between 60 and 65° F. (15.6-18.3 C), then stored at 4° C. Almond yogurt compositions with and without sensory modifier are outlined in Table 21.

TABLE 21

| | | Sensory | Sensory | Sensory |
|---|---|---|---|---|
| | | Modifier | Modifier | Modifier |
| Ingredient | Control | 100 ppm | 150 ppm | 200 ppm |
| Almond cream | 22.40% | 22.40% | 22.40% | 22.40% |
| Tapioca starch | 4.10% | 4.10% | 4.10% | 4.10% |
| Sucrose | 5.80% | 5.80% | 5.80% | 5.80% |
| Salt | 0.05% | 0.05% | 0.05% | 0.05% |
| Water | 65.62% | 65.61% | 65.605% | 65.60% |
| Potassium sorbate | 0.03% | 0.03% | 0.03% | 0.03% |
| Pea protein | 2.00% | 2.00% | 2.00% | 2.00% |
| Sensory modifier | — | 0.01% | 0.015% | 0.02% |

*all values provided as wt %

### Example 11—Ice Cream

Assays were carried out to characterize the sensory attributes of dairy-free ice cream with various amount of the sensory modifier, a pea masker, and/or a caramel espresso flavor. Pea protein flavor and flavor sensory attributes were analyzed by a panel of five individuals using a roundtable consensus approach. Panelists were experienced in sensory testing. The composition of the dairy-free ice cream is outline in Table 22. The dairy-free ice cream samples were prepared by pre-heating the water phase, which includes water, almond milk, and hydrocolloid, to between 90-100° F. (32.2-37.8° C.). The pea protein is added and hydrated for 10-15 minutes in the pre-heated water phase. Following hydration of the pea protein, the vegetable glycerin, liquid sugar, lecithin concentrate, and the potassium sorbate are blended and added to the composition. The coconut oil is melted and into the composition. The composition is then homogenized at 2000 psi (1500 psi 1^{st}/500 psi 2^{nd}), pre-heated to 140° F. (60° C.), pasteurized at 185° F. (85° C.) for 30 seconds, then cooled to 40° F. (4.4° C.) and aged overnight. After cooling and aging, the composition is frozen at or below 32° F. (0° C.). For samples 11.2, 11.3, 11.4, and 11.5, the sensory modifier, a commercially available pea flavor masker, and/or caramel espresso flavor were added to the composition at the appropriate concentration before freezing. Sensory attribute results of the ice cream composition are outlined in Table 23.

TABLE 22

| | |
|---|---|
| Water | 7.420% |
| Almond milk | 57.600% |
| Coconut oil | 4.300% |
| Liquid sugar (67.5%) | 17.80% |
| Corn syrup solids | 6.00% |
| Pea protein | 4.100% |
| Vegetable glycerin | 1.00% |
| Hydrocolloid and lecithin concentrate | 0.65% |
| (locust bean gum, guar gum, canola lecithin) | |
| Potassium Sorbate | 0.03% |

all values provided as wt %

TABLE 23

| | Samples | | | | |
|---|---|---|---|---|---|
| | 11.1 | | | | |
| | (control) | 11.2 | 11.3 | 11.4 | 11.5 |
| Sensory | — | 150 ppm | 150 ppm | — | — |
| Modifier | | | | | |
| Caramel | — | — | 0.1 (wt) % | — | 0.1 (wt) % |
| espresso | | | | | |
| flavor | | | | | |
| Pea masker | — | — | — | 0.2 (wt) % | 0.2 (wt) % |
| Sensory | Intense | Delayed | Muted caramel | Maximum | Pea protein flavor |
| Attribute | upfront and | onset and | flavor, strong | intensity of the | was reduced but |
| Comments | lingering | reduced | and bright | pea protein | still present and |
| | pea protein | intensity of | espresso/coffee | flavor was | lingering. Caramel |
| | flavor | pea protein | flavor, pea | reduced | flavor was |
| | | flavor as | protein flavor | relative to | dominating the |
| | | compared to | onset was | 11.1, but was | characterizing |
| | | 11.1. The | further delayed | still | profile, but the |
| | | residual pea | with extremely | consistently | coffee/espresso |
| | | protein flavor | reduced intensity | present | flavor notes were |
| | | was muted | (trace) | throughout | greatly reduced and |
| | | compared to | | with early | muted resulting in |
| | | the pea | | onset and | an altered |
| | | protein flavor | | lingering | characterizing |
| | | in 11.1 | | presence | flavor profile |

### Example 12—Sensory Assessment of Plant Based Protein Solutions

Assays were carried out to characterize the sensory attributes of plant-based protein isolates from a variety of botanical sources. Sensory attribute intensity scores were determined by a panel of at least 6 individuals. Panelists were experienced in sensory testing. All panelists used the plant protein assay method described above, and individual sensory attribute intensity scores were averaged for reporting below. Plant-based protein solutions were prepared by mixing the plant-based protein isolate with water. For the compositions including the sensory modifier, the sensory modifier was added to the water prior to mixing with the plant-based protein isolate. The plant-based protein isolate solutions tested are outlined in Table 24.

TABLE 24

| | Ingredients | | | | |
|---|---|---|---|---|---|
| | Protein | Protein Source | Water | Sensory | |
| Samples | Source | (wt %) | (wt %) | Modifier (wt %) | pH |
| 12.1 | High Viscosity | 5 | 95 | 0 | 7.19 |
| | Chickpea | | | | |
| 12.2 | High Viscosity | 5 | 94.97 | 0.03 | 7.06 |
| | Chickpea | | | | |
| 12.3 | Low Viscosity | 5 | 95 | 0 | 6.61 |
| | Chickpea | | | | |
| 12.4 | Low Viscosity | 5 | 94.97 | 0.03 | 6.60 |
| | Chickpea | | | | |
| 12.5 | Rice | 5 | 95 | 0 | 5.58 |
| 12.6 | Rice | 5 | 94.97 | 0.03 | 5.60 |
| 12.7 | Sunflower | 5 | 95 | 0 | 6.05 |
| 12.8 | Sunflower | 5 | 94.97 | 0.03 | 6.03 |
| 12.9 | Potato | 5 | 95 | 0 | 7.02 |
| 12.10 | Potato | 5 | 94.97 | 0.03 | 6.94 |

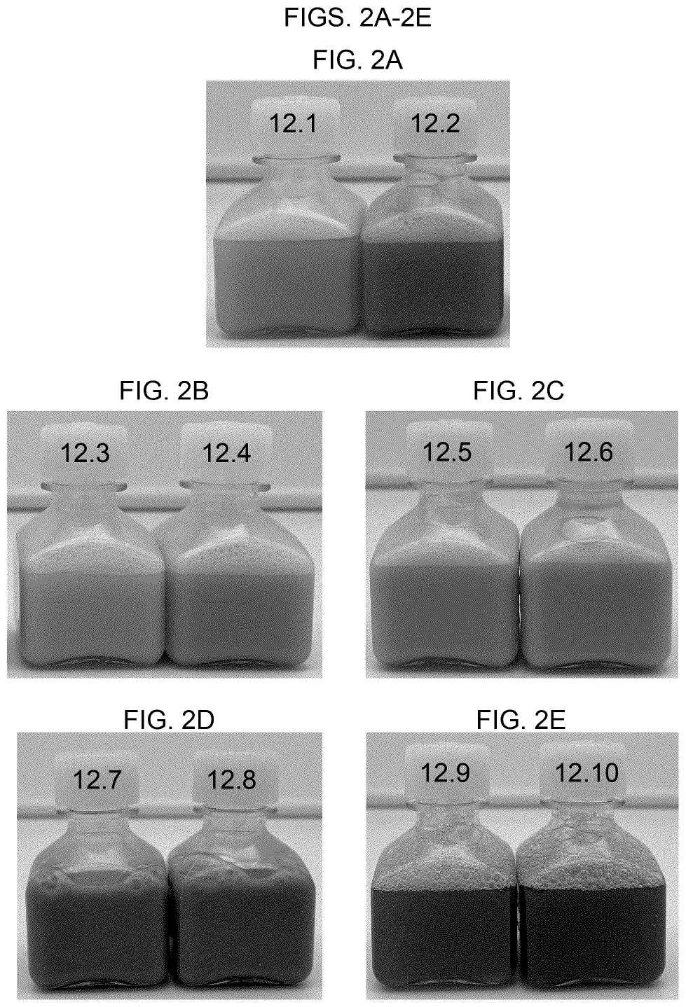

Most of the plant-based protein solutions had a pH close to neutral, except rice and sunflower protein which has a pH of 5.58 and 6.05, respectively. When sensory modifier was added to the chickpea and potato solutions, the solutions appeared a dark gray/green color (FIGS. 2A, 2B, and 2E). However, when the sensory modifier was added to the rice and sunflower solutions, no color change was observed (FIGS. 2C and 2D). The addition of the sensory modifier did not have a significant effect on pH (Table 24).

The sensory attributes of overall aroma and viscosity were evaluated for all samples. In addition to overall aroma and viscosity, the panelists collectively selected 4 additional sensory attributes that were most predominant for each plant-based protein source and compared said attributes between the samples prepared with and without the sensory modifier. The list of sensory attributes assayed for each plant-based protein source is shown in Tables 25-29 below and sensory attribute definitions are provided in Table 30. As shown in Table 25, the intensity of soy/tofu and what sensory attributes were reduced when the sensory modifier was added to the high viscosity chickpea protein solutions. For the low viscosity chickpea solutions, the addition of the sensory modifier decreased the intensity of astringency (Table 26). The addition of the sensory modifier to the solution of rice protein decreased the intensity of the play dough notes (Table 27). As shown in Table 28, the intensity of hully, cardboard, and astringency were reduced in the sunflower protein sample prepared with the sensory modifier. For the potato protein isolate solutions, the addition of the sensory modifier reduced the intensity of potato peel notes (Table 29).

TABLE 25

| | Sample | |
|---|---|---|
| Sensory Attribute | 12.1 | 12.2 |
| Overall Aroma | 6.3 | 5.7 |
| Bitter | 3.8 | 3.2 |
| Soy/Tofu | 4.3 | 3.3 |
| Wheat | 4.8 | 3.4 |
| Chalky | 2.3 | 2.2 |
| Viscosity | 4.5 | 4.0 |

TABLE 26

| | Sample | |
|---|---|---|
| Sensory Attribute | 12.3 | 12.4 |
| Overall Aroma | 6.2 | 6.0 |
| Bitter | 4.8 | 4.3 |
| Wheat | 4.3 | 3.5 |
| Astringency | 3.8 | 2.8 |
| Chalky | 5.2 | 4.7 |
| Viscosity | 3.7 | 3.5 |

TABLE 27

| | Sample | |
|---|---|---|
| Sensory Attribute | 12.5 | 12.6 |
| Overall Aroma | 5.5 | 5.1 |
| Flour | 4.2 | 3.3 |
| Play dough | 4.4 | 3.0 |
| Astringency | 5.4 | 4.6 |
| Chalky | 6.9 | 6.1 |
| Viscosity | 1.6 | 1.6 |

TABLE 28

| | Sample | |
|---|---|---|
| Sensory Attribute | 12.7 | 12.8 |
| Overall Aroma | 4.9 | 4.4 |
| Bitter | 3.4 | 2.9 |
| Hully | 4.9 | 3.7 |
| Cardboard | 4.7 | 3.7 |
| Astringent | 4.1 | 2.9 |
| Viscosity | 1.6 | 1.5 |

TABLE 29

| | Sample | |
|---|---|---|
| Sensory Attribute | 12.9 | 12.10 |
| Overall Aroma | 6.6 | 6.3 |
| Bitter | 3.1 | 2.9 |
| Earthy | 5.1 | 5.1 |
| Potato peel | 7.9 | 6.8 |
| Mushroom | 4.1 | 3.6 |
| Viscosity | 0.9 | 0.9 |

TABLE 30

| Modality | Attribute | Definition |
|---|---|---|
| Aroma | Overall aroma | Overall aroma |
| Taste | Bitter | Taste common to caffeine |
| Flavor | Soy/Tofu | The flavor reminiscent of say |
| | | products such as tofu or |
| | | unsweetened soy milk. |
| | Wheat | The flavor associated with wheat |
| | | ingredients, such as wheat |
| | | flour, wheat crackers, or wheat cereals |
| | Hully | The aromatics associated with |
| | | the outer shell of a peanut |
| | Cardboard | The aromatics associated with |
| | | wet brown cardboard boxes, |
| | | cereal boxes, shipping boxes |
| | Flour | The flavor reminiscent of white flour in water |
| | Earthy | The aromatics associated with |
| | | decaying vegetation and damp, |
| | | black soil |
| | Potato peel | The aromatics associated with |
| | | wet russet potato skins |
| | Mushroom | The earthy flavor of mushrooms, |
| | | excluding any umami taste |
| | “Play-Doh” | The aromatics reminiscent of the |
| | | play dough sold under the |
| | | tradename PLAY-DOH |
| Texture & | Astringent | Mouth drying sensation felt in |
| Mouthfeel | | different parts of the mouth |
| | Chalky | Presence of very small powder or |
| | | dusty like particles, leaving |
| | | a residual coating both in mouth |
| | | and after expectorating |
| | Viscosity | The rate of the product to flow over tongue |

### Example 13—Sensory Assessment of Pea Protein Solutions

Assays were carried out to characterize the sensory attributes of various pea protein isolates. Pea protein isolates included standard isoelectric precipitation extracted pea protein, hydrolyzed pea protein, low-sodium pea protein, and enzyme modified pea protein. Sensory attribute intensity scores were determined by a panel of at least 5 individuals. Panelists were experienced in sensory testing. All panelists used the plant protein assay method described above, and individual sensory attribute intensity scores were averaged for reporting below. Pea protein solutions were prepared by mixing the pea protein isolate with water. For the compositions including the sensory modifier, the sensory modifier was added to the water prior to mixing with the pea protein isolate. The pea protein isolate solutions tested are outlined in Table 31.

TABLE 31

| | Ingredients | | | | |
|---|---|---|---|---|---|
| | | Protein | | Sensory | |
| | | Source | Water | Modifier | |
| Samples | Protein source | (wt %) | (wt %) | (wt %) | pH |
| 13.1 | standard isoelectric | 5 | 95 | 0 | 7.47 |
| | precipitation extracted | | | | |
| | pea protein | | | | |
| 13.2 | standard isoelectric | 5 | 94.97 | 0.03 | 7.38 |
| | precipitation extracted | | | | |
| | pea protein | | | | |
| 13.3 | hydrolyzed pea protein | 5 | 95 | 0 | 7.32 |
| 13.4 | hydrolyzed pea protein | 5 | 94.97 | 0.03 | 7.26 |
| 13.5 | enzyme modified pea | 5 | 95 | 0 | 6.97 |
| | protein | | | | |
| 13.6 | enzyme modified pea | 5 | 94.97 | 0.03 | 6.90 |
| | protein | | | | |
| 13.7 | low-sodium pea | 5 | 95 | 0 | 7.42 |
| | protein | | | | |
| 13.8 | low-sodium pea | 5 | 94.97 | 0.03 | 7.33 |
| | protein | | | | |

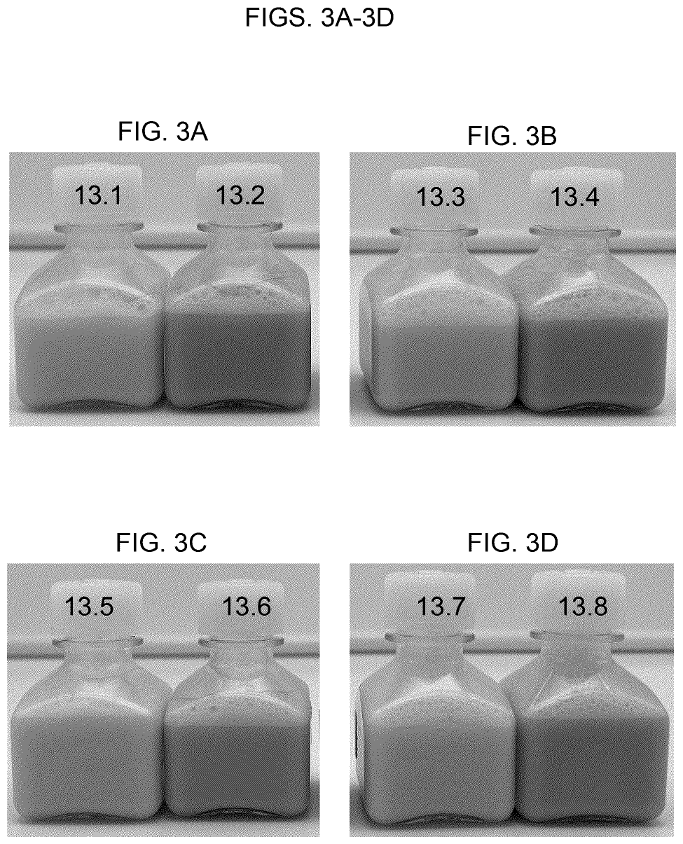

Most of the plant-based protein solutions had a pH close to neutral. The addition of the sensory modifier did not have a significant effect on pH (Table 31). When sensory modifier was added to the pea protein isolate solutions, the solutions appeared a dark gray/green color (FIGS. 3A-3D).

The sensory attributes of biller and viscosity were evaluated for all samples. In addition to biller and viscosity, the panelists collectively additional sensory attributes that were most predominant for each pea protein isolate and compared said attributes between the samples prepared with and without the sensory modifier. Sensory attribute definitions are provided in Table 33. The list of sensory attributes assayed for each plant-based protein source is shown in Table 32.

As shown in Table 32, samples that included the sensory modifier had a reduction in the intensity of one or more sensory attributes relative to the equivalent pea protein isolate solution without the sensory modifier. For example, when the sensory modifier was added to the standard pea protein isolate, the sample had decreased bitter, pea, and grassy/green intensity. In samples prepared with hydrolyzed pea protein, the sample with the sensory modifier had reduced bitter intensity relative to the sample without the sensory modifier. For the samples prepared with the enzyme modified pea protein, addition of the sensory modifier showed a reduction in pea and green/grassy intensity. Finally, the sample with the low sodium and the sensory modifier had reduced bitter, pea, astringency, and chalkiness intensity relative to the sample with pea protein isolate alone.

TABLE 32

| Sensory | Sample | | | | | | | |
|---|---|---|---|---|---|---|---|---|
| Attribute | 13.1 | 13.2 | 13.3 | 13.4 | 13.5 | 13.6 | 13.7 | 13.8 |
| Bitter | 4.8 | 2.6 | 7.7 | 6.2 | 2.6 | 2.5 | 6.8 | 5.4 |
| Pea | 4.7 | 3.3 | — | — | 4.3 | 2.6 | 3.6 | 2.6 |
| Green/Grassy | 5.4 | 4.2 | 2.8 | 2.8 | 3.1 | 1.7 | — | — |
| Viscosity | 3.2 | 3.2 | 2.4 | 2.0 | 4.1 | 3.5 | 2.5 | 2.6 |
| Astringent | — | — | 5.6 | 5.2 | — | — | 4.3 | 2.9 |
| Chalky | — | — | 6.2 | 5.4 | — | — | 6.1 | 4.9 |

Blank spaces indicate sensory attribute(s) that were not assessed for the given sample

TABLE 33

| Modality | Attribute | Definition |
|---|---|---|
| Taste | Bitter | Taste common to caffeine |
| Flavor | Pea | The aromatics associated with |
| | | cooked split peas |
| | Green/Grassy | The aromatics associated with |
| | | freshly cut vegetation |
| Texture & | Astringent | Mouth drying sensation felt in |
| Mouthfeel | | different parts of the mouth |
| | Chalky | Presence of very small powder or |
| | | dusty like particles, leaving a |
| | | residual coating both in mouth |
| | | and after expectorating |
| | Viscosity | The rate of the product to flow over tongue |

1. A dairy substitute composition comprising:
a hydrocolloid, a starch, or a combination thereof,
a lipid composition, a plant-based protein, or a combination thereof, and
between 0.001% (wt) and 1.0% (wt) of a sensory modifier comprising
a dicaffeoylquinic acid or salt thereof; and
at least one compound selected from the group consisting of monocaffeoylquinic acids, monoferuloylquinic acids, diferuloylquinic acids, monocoumaroylquinic acids, dicoumaroylquinic acids, and salts thereof.

2. (canceled)

3. (canceled)

4. The composition of claim 1, wherein the sensory modifier is 0.01% to 0.5% by weight of the composition.

5. The composition of claim 1, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof; and wherein the sensory modifier comprises a monocaffeoylquinic component selected from the group consisting of chlorogenic acid, neochlorogenic acid, cryptochlorogenic acid, and salts thereof.

6. The composition of claim 1, wherein the total of all dicaffeoylquinic acids and dicaffeoylquinic salts present in the sensory modifier comprises 10% (wt) or more, 15 wt % or more, 20% (wt) or more, 25% (wt) or more, 30% (wt) or more, 35% (wt) or more, 40% (wt) or more, 45% (wt) or more, 50% (wt) or more, 60% (wt) or more, 70% (wt) or more, 25-75% (wt), or 40-60% (wt) of a total weight of the sensory modifier.

7. (canceled)

8. The composition of claim 1, wherein the sensory modifier comprises a monocaffeoylquinic component and a dicaffeoylquinic component that together comprise more than 50% (wt) of the sensory modifier.

9. (canceled)

10. The composition of claim 1, wherein the plant-based protein is selected from the group consisting of pea protein, soy protein, corn protein, potato protein, wheat protein, pulse protein, chickpea protein, canola protein, rice protein, sunflower protein, and combinations thereof.

11. The composition of claim 1, wherein the composition comprises 0.5% (wt) to 20% (wt) of the plant-based protein isolate.

12. The composition of claim 1, wherein the composition comprises 1% (wt) to 30% (wt) of the lipid composition.

13. The composition of claim 1, wherein the lipid composition comprises an oil selected from the group consisting of coconut oil, palm oil, sunflower oil, soy oil, canola oil, vegetable oil, and combinations thereof.

14. The composition of claim 1, wherein the composition comprises 1% (wt) to 20% (wt) starch.

15. The composition of claim 1, wherein the composition comprises a hydrocolloid comprising guar gum, xanthan gum, carrageenan, locust bean gum, cellulose, konjac gum, or combinations thereof.

16. The composition of claim 1, wherein the composition comprises between 0.1% (wt) and 10.0% (wt) of the hydrocolloid.

17. The composition of claim 1, wherein the composition comprises 0.01% (wt) and 10.0% (wt) of lecithin.

18. The composition of claim 1, wherein the composition comprises between 15% and 80% by weight of a plant-based milk product.

19. (canceled)

20. The composition of claim 1, wherein the combination of water and plant-based milk product in the composition is between 50% and 95% by weight of the composition.

21. The composition of claim 1, wherein sourness of the composition is increased relative to sourness in an equivalent composition prepared without the sensory modifier.

22. The composition of claim 1, wherein the composition comprises a plant-based protein and plant protein flavor of the composition is reduced relative to plant protein flavor in an equivalent composition prepared without the sensory modifier.

23. The composition of claim 1, wherein the composition comprises lactic acid and lactic flavor of the composition is increased relative to lactic flavor in an equivalent composition prepared without the sensory modifier.

24. (canceled)

25. The composition of claim 1, wherein the composition is a dairy-free cheese, a dairy-free yogurt, or a dairy-free ice cream.

26. A method for increasing lactic flavor in a dairy substitute composition, the method comprising,
adding a sensory modifier to a dairy substitute composition comprising
a hydrocolloid, a starch, or a combination thereof,
a lipid composition, a plant-based protein, or a combination thereof;
to form a modified dairy substitute, the sensory modifier comprising a dicaffeoylquinic acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof,
wherein lactic flavor of the composition is increased relative to lactic flavor in an equivalent composition prepared without the sensory modifier.

27. A method for increasing sourness in a dairy substitute composition, the method comprising,
adding a sensory modifier to a dairy substitute composition comprising
a hydrocolloid, a starch, or a combination thereof,
a lipid composition, a plant-based protein, or a combination thereof;
to form a modified dairy substitute, the sensory modifier comprising a dicaffeoylquinic acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof,
wherein sourness of the composition is increased relative to sourness in an equivalent composition prepared without the sensory modifier.

28.-47. (canceled)
